(19) United States
(12) Patent Application Publication
(10) Pub. No.: US 2018/0061181 A1
(43) Pub. Date: Mar. 1, 2018

(54) ADAPTIVE WAGERING SYSTEM

(71) Applicant: Gamblit Gaming, LLC, Glendale, CA (US)

(72) Inventors: Eric Meyerhofer, Pasadena, CA (US); Bryce Cire, Los Angeles, CA (US); Frank Cire, Pasadena, CA (US); Ivan Souffant, Sunland, CA (US)

(21) Appl. No.: 15/694,738

(22) Filed: Sep. 1, 2017

Related U.S. Application Data
(60) Provisional application No. 62/382,747, filed on Sep. 1, 2016.

(51) Int. Cl. G07F 17/32

(52) U.S. Cl. CPC G07F 17/3244; G07F 17/3211; G07F 17/3209; G07F 17/3295

(57) ABSTRACT

An adaptive wagering system is disclosed. The adaptive wagering system has an interactive controller, a skill bonus controller, and a process controller constructed to communicate with the interactive controller and the skill bonus controller. The adaptive wagering system also has an enclosure constructed to mount a user input device operatively connected to the interactive controller, a user output device operatively connected to the interactive controller, a credit input device operatively connected to the process controller, and a credit output device operatively connected to the process controller.

### CROSS REFERENCE TO RELATED APPLICATIONS

This application claims the benefit of U.S. Provisional Application No. 62/382,747, filed Sep. 1, 2016, the contents of which are incorporated by reference herein in their entirety.

### FIELD OF THE INVENTION

Embodiments of the invention are generally related to data processing systems for processing wagering data. More particularly, the invention relates to the communication and processing of wagering data.

### BACKGROUND

The gaming industry has traditionally developed data processing systems that implement simple wagers. However, more complicated wagering processes need communication and processing systems that are better suited for implementing these more complicated wagering processes. Various aspects of embodiments of the invention meet such a need.

### SUMMARY OF THE INVENTION

Systems and methods in accordance with embodiments of the invention provide a communication and data processing system constructed for an adaptive wagering system.

In an embodiment, an adaptive wagering system is provided. The adaptive wagering system includes an interactive controller, a skill bonus controller, and a process controller constructed to communicate with the interactive controller and the skill bonus controller.

In some embodiments, the interactive controller and the process controller are constructed from the same device.

In various embodiments, the process controller is operatively connected to the interactive controller using a communication link.

In many embodiments, the adaptive wagering system further includes an enclosure constructed to mount a user input device operatively connected to the interactive controller, a user output device operatively connected to the interactive controller, a credit input device operatively connected to the process controller, and a credit output device operatively connected to the process controller.

In many embodiments, the adaptive wagering system further includes a random number generator, wherein the process controller is further constructed to: communicate with the credit input device to receive a credit input, credit a credit meter with credits based on the incoming credit data, generate a random outcome based on a random outcome generated by the random number generator, determine a skill proposition based on the random outcome, communicate the skill proposition to the interactive controller, receive a skill outcome from the interactive controller, update the credit meter based on a chance outcome of the wager, and communicate with the credit output device to generate a credit output based on credits transferred off of the credit meter. The interactive controller is further constructed to receive the skill proposition from the process controller, generate a player presentation based on the skill proposition, detect player interactions with the player presentation, determine a skill outcome based on the player interactions and the skill proposition, and communicate the skill outcome to the process controller.

In an embodiment of the invention, a process controller operates as an interface between an interactive controller that determines skill outcomes and a wager subcontroller that determines random outcomes. By virtue of this feature, the wager subcontroller is isolated from the interactive controller allowing the interactive controller to operate in an unregulated environment while allowing the wager subcontroller to operate in a regulated environment, thus providing for more efficient management of the operations of such a system.

In another embodiment of the invention, a single wager subcontroller may provide services to two or more interactive controllers, thus allowing an adaptive wagering system to operate more efficiently over a large range of scaling.

In another embodiment of the invention, multiple types of interactive controllers using different operating systems may be interfaced to a single type of process controller without requiring customization of the process controller and/or the wager subcontroller, thus improving the efficiency of the process controller and/or the wager subcontroller by reducing complexity associated with maintaining separate process controllers and/or wager subcontrollers for each type of interactive controller.

In another embodiment of the invention, an interactive controller may be provided as a player device under control of a player while maintaining the process controller in an environment under the control of a regulated operator of wagering equipment, thus providing for a more economical system as the regulated operator need not expend capital to purchase interactive controllers.

In another embodiment of the invention, data communicated between the controllers may be encrypted to increase security of the adaptive wagering system.

In another embodiment of the invention, a process controller isolates random outcome logic and skill proposition logic as unregulated logic from a regulated wager subcontroller, thus allowing errors in the skill proposition logic and/or random outcome logic to be corrected, new skill proposition logic and/or random outcome logic to be used, or modifications to be made to the skill proposition logic and/or random outcome logic without a need for time-consuming regulatory approval.

In another embodiment of the invention, an interactive application may require extensive processing resources from an interactive controller leaving few processing resources for the functions performed by a process controller and/or a wager subcontroller. By virtue of an architecture of some embodiments of the invention, processing loads may be distributed across multiple devices such that operations of the interactive controller may be dedicated to an interactive application and the processes of the process controller and/or wager subcontroller are not burdened by the requirements of the interactive application.

In another embodiment of the invention, an adaptive wagering system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like. In many such embodiments, one or more components of an adaptive wagering system are distributed in close proximity to each other and communicate using a local area network and/or a communication bus. In several embodiments, an interactive controller and a process controller of an adaptive wagering system are in a common location. In some embodiments, a process controller communicates with an external interactive controller. In various embodiments, these multiple controllers and sub-controllers can be constructed from or configured using a single device or a plurality of devices such that an adaptive wagering system is executed as a system in a virtualized space such as, but not limited to, where a wager subcontroller and a process controller are large scale centralized servers and are operatively connected to distributed interactive controllers via a wide area network such as the Internet or a local area network. In such embodiments, the components of an adaptive wagering system may communicate using a networking protocol or other type of device-to-device communications protocol.

In another embodiment of the invention, an interactive controller is an interactive server acting as a host for managing head-to-head player interactions over a network of interactive sub-controllers connected to the interactive server using a communication link. The interactive server provides an environment where players can compete directly with one another and interact with other players.

### BRIEF DESCRIPTION OF THE DRAWINGS

FIG. 1 is a diagram of a structure of an adaptive wagering system in accordance with various embodiments of the invention.

FIG. 2A is a diagram of an electronic gaming machine configuration of an adaptive wagering system in accordance with various embodiments of the invention.

FIG. 2B is a diagram of a table electronic gaming machine configuration of an adaptive wagering system in accordance with various embodiments of the invention.

FIG. 3 is a diagram of distributed adaptive wagering systems in accordance with various embodiments of the invention.

FIGS. 4A and 4B are diagrams of a structure of an interactive controller of an adaptive wagering system in accordance with various embodiments of the invention.

FIG. 5 is a diagram of a structure of a process controller of an adaptive wagering system in accordance with various embodiments of the invention.

FIG. 6 is a diagram of a structure of a credit processing system of an adaptive wagering system in accordance with various embodiments of the invention.

FIG. 7 is a diagram of a structure of a credit processing system in accordance with various embodiments of the invention.

FIG. 8A is a block diagram of a process of an adaptive wagering system during a wagering session in accordance with various embodiments of the invention.

FIG. 8B is a block diagram of a paired wagering proposition of an adaptive wagering system during a wagering session in accordance with various embodiments of the invention.

FIG. 8C is a diagram illustrating a paired wagering outcome in accordance with various embodiments of the invention.

FIG. 9 is a sequence diagram of interactions between components of an adaptive wagering system during a wagering session in accordance with various embodiments of the invention.

FIG. 10 is a state diagram of a wagering process of a wagering process in accordance with an embodiment of the invention.

FIG. 11 is a process flow diagram of a wagering process in accordance with an embodiment of the invention.

FIG. 12 is another process flow diagram of a wagering process in accordance with an embodiment of the invention.

FIG. 13 is another process flow diagram of a wagering process in accordance with an embodiment of the invention.

### DETAILED DESCRIPTION

An adaptive wagering system allows for the management of a paired wagering proposition having a skill proposition for one or more players where the skill proposition is associated with one or more random outcomes generated in accordance with a chance-based wager proposition. In some embodiments of an adaptive wagering system, an interactive application executed by an interactive controller provides skill proposition components of the adaptive wagering system. The interactive controller is operatively connected to a process controller that manages and configures the interactive controller and the interactive application, and determines skill propositions associated with random outcomes determined by a wager subcontroller that are resolved as skill outcomes determined by the interactive application.

In some embodiments, the interactive controller also provides a wagering user interface that is used to receive commands and display data for a wagering process and wagering outcome determined from the skill outcome in accordance with a paired wagering proposition. The content of the wagering user interface is controlled by the process controller and includes content provided by the wager subcontroller and the interactive controller.

In various embodiments, an interactive controller provides a management user interface used to manage a player profile.

Many different types of interactive applications may be utilized with the adaptive wagering system. In some embodiments, the interactive application reacts to the physical activity of a player. In these embodiments, the interactive application senses player interactions with the interactive application through one or more sensors that monitor the player's physical activities. Such sensors may include, but are not limited to, physiological sensors that monitor the physiology of the player, environmental sensors that monitor the physical environment of the interactive controller, accelerometers that monitor changes in motion of the interactive controller, and location sensors that monitor the location of the interactive controller such as global positioning sensors.

In some embodiments, the interactive application implements a skill-based game and interacts with the player by sensing skillful interactions with an interactive user interface generated by the interactive application.

In many embodiments, the interactive application generates various types of interactive elements in an interactive application environment. In some embodiments, these interactive elements are interactive application resources utilized within the interactive application environment to provide an interactive experience for a player.

In accordance with some embodiments, a random outcome associated with the skill proposition can influence interactive elements in the interactive application environment such as, but not limited to, automatically providing one or more new interactive elements, automatically restoring one or more consumed interactive elements, automatically causing the loss of one or more interactive elements, and automatic restoration or placement of one or more fixed interactive elements.

In various embodiments, the wagers may be made using one or more credits.

In some embodiments, credits can be one or more credits that are purchased using, and redeemed in, a real world currency having a real world value.

In many embodiments, credits can be one or more credits in a virtual currency. Virtual currency is an alternate currency that can be acquired, purchased or transferred by or to a player, but does not necessarily directly correlate to a real world currency. In many such embodiments, credits in a virtual currency are allowed to be purchased using a real world currency but are prevented from being redeemed in a real world currency having a real world value.

In several embodiments, interaction with the interactive elements of the interactive application, application credits can be optionally consumed and/or accrued within the interactive application as a result of interaction with the interactive elements. Application credits can be in the form of, but not limited to, application environment credits, experience points, and points generally.

In various embodiments, application credits are awarded on the basis of skillful interactions with the interactive elements of a skill-based interactive application. The skill-based interactive application can have one or more skill scores, embedded within a process controller and/or an interactive controller that provides the skill-based interactive application, that can be used to determine player performance against one or more skill objectives of the skill-based interactive application in accordance with a skill proposition.

In many embodiments, application credits can be used to purchase in-application items, including but not limited to, application interactive elements that have particular properties, power ups for existing items, and other item enhancements.

In some embodiments, application credits may be used to earn entrance into a sweepstakes drawing, to earn entrance in a tournament with prizes, to score in the tournament, and/or to participate and/or score in any other game event.

In several embodiments, application credits can be stored on a player-tracking card, voucher or in a network-based player tracking system where the application credits are attributed to a specific player.

In many embodiments, a paired wagering proposition includes a wager of application credits for payout of application credits, interactive application elements, and/or interactive application objects in accordance with the chance-based wager proposition.

In a number of embodiments, a wager of an amount of credits results in a payout of application credits, interactive elements, and/or interactive application objects that have a credit value if cashed out.

In some embodiments, interactive application objects include in-application objects that may be utilized to enhance player interactions with the interactive application. Such objects include, but are not limited to, power-ups, enhanced in-application items, and the like. In some embodiments, the interactive application objects include objects that are detrimental to player interactions with the interactive application such as, but not limited to, obstructions in the interactive application space, a temporary handicap, an enhanced opponent, and the like.

In numerous embodiments, an interactive application command is an instruction by a process controller to an interactive controller and/or an interactive application of the interactive controller to modify a state of an interactive application or modify one or more interactive application resources or interactive elements. In some embodiments, the interactive application commands may be automatically generated by the process controller using one or more of a random outcome and/or application environment variables. An interactive application command can be used by a process controller control many processes of an interactive application, such as, but not limited to, an causing an addition of a period of time available for a current interactive application session for the interactive application, an addition of a period of time available for a future adaptive wagering system interactive application session or any other modification to the interactive application interactive elements that can be utilized during an interactive application session.

In some embodiments, asynchronous communications provided for by an adaptive wagering system may reduce an amount of idle waiting time by an interactive controller of the adaptive wagering system, thus increasing an amount of processing resources that the interactive controller may provide to an interactive application or other processes of the interactive controller. In many embodiments, asynchronous communications provided for by an adaptive wagering system reduces an amount of idle waiting time by a process controller, thus increasing an amount of processing resources that the process controller may provide to determine random outcomes, and other processes provided by the process controller.

In some embodiments, a wager subcontroller of an adaptive wagering system may be operatively connected to a plurality of interactive controllers through a process controller and the asynchronous communications provided for by the process controllers allows the wager subcontroller to operate more efficiently by providing one or more random outcomes to a larger number of interactive controllers than would be achievable without the process controller of the adaptive wagering system.

In some embodiments, an adaptive wagering system including a process controller operatively connected to a wager subcontroller and operatively connected to an interactive controller wherein the process controller provides for simplified communication protocols for communications of the interactive controller as the interactive controller may communicate interactions with an interactive application provided by the interactive controller to the process controller without regard to a nature of a chance-based wager proposition.

In various embodiments, an adaptive wagering system including a process controller operatively connected to a wager subcontroller and operatively connected to an interactive controller may provide for simplified communication protocols for communications of the wager subcontroller as the wager subcontroller may receive skill proposition requests and communicate determined skill propositions associated with random outcomes without regard to a nature of an interactive application provided by the interactive controller.

In some embodiments, an adaptive wagering system including a process controller operatively connecting a wager subcontroller to an interactive controller may provide for reduced processing requirement for the interactive controller by offloading the execution of a random number generator from the interactive controller to the process controller. In various such embodiments, additional processing resources may be made available to graphics processing or other processing intensive operations by the interactive controller because of the offloaded random number processing.

In various embodiments, an adaptive wagering system including a process controller operatively connecting a wager subcontroller to an interactive controller provides for operation of the interactive controller in an unsecure location or manner, while providing for operation of the wager subcontroller in a secure location or manner.

In some embodiments, an adaptive wagering system including a process controller operatively connecting a wager subcontroller to an interactive controller allows the skill wagering system to have regulated components coupled to unregulated components in a heterogeneous regulated environment. For example, in several such embodiments, the interactive controller may be a device that is not regulated by a wagering regulatory agency whereas the wager subcontroller is regulated by the wagering regulatory agency. A process controller of an adaptive wagering system may provide for isolation of the processing of the interactive controller from the processing of the wager subcontroller. In such a heterogeneous regulatory environment, the process controller may or may not be itself a regulated by the wagering regulatory authority. In addition, components of an interactive application executed by the interactive controller may be either regulated or unregulated by the wagering regulatory agency.

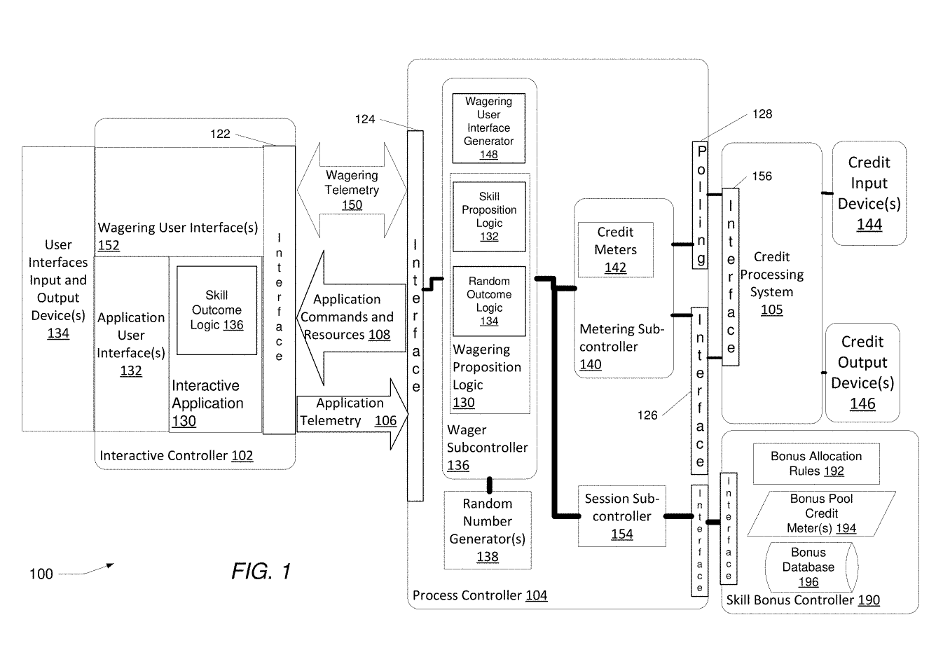

FIG. 1 is a diagram of a structure of an adaptive wagering system in accordance with various embodiments of the invention. The adaptive wagering system 100 includes an interactive controller 102, a process controller 104, and a credit processing system 105. The interactive controller 102 is operatively connected to, and communicates with, the process controller 104. The process controller 104 is also operatively connected to, and communicates with, the credit processing system 105.

In various embodiments, the interactive controller 102 executes an interactive application 110 and provides one or more user interface input and output devices 114 so that one or more players can interact with the interactive application 110. In various embodiments, user interface input devices include, but are not limited to: buttons or keys; keyboards; keypads; game controllers; joysticks; computer mice; track balls; track buttons; touch pads; touch screens; accelerometers; motion sensors; video input devices; microphones; and the like. In various embodiments, user interface output devices include, but are not limited to: audio output devices such as speakers, headphones, earbuds, and the like; visual output devices such as lights, video displays and the like; and tactile devices such as rumble pads, hepatic touch screens, buttons, keys and the like. The interactive controller 102 provides for player interactions with the interactive application 110 by executing the interactive application 110 that generates an application user interface 112 that utilizes the user interface input devices to detect player interactions with the interactive controller 102 and generates an interactive user interface that is presented to the player utilizing the user interface output devices.

In some embodiments, one or more components an interactive controller are housed in an enclosure such as a housing, cabinet, casing or the like. The enclosure further includes one or more player accessible openings or surfaces that constructed to mount the user interface input devices and/or the user interface output devices.

The interactive controller 102 is operatively connected to, and communicates with, the process controller 104. The interactive controller 102 receives application command and resource data 108 including skill proposition data, application command data, and resource data, from the process controller 104. Via the communication of the application command and resource data 108, the process controller 104 can control the operation of the interactive controller 102 by communicating control parameters to the interactive application 110 during the interactive application's execution by the interactive controller 102.

In some embodiments, during execution of the interactive application 110 by the interactive controller 102, the interactive controller 102 communicates, as application telemetry data 106, player interactions with one or more interactive elements of the application user interfaces 112 of the interactive application to the process controller 104. the application telemetry data 106 may include, but is not limited to, application environment variables that indicate the state of the interactive application 110, interactive controller data indicating a state of the interactive controller 102, player actions and interactions between one or more players and the interactive application 110 provided by the interactive controller 102, and utilization of interactive elements in the interactive application 110 by one or more players.

In some embodiments, the application telemetry 106 includes a skill outcome as determined by the interactive application 110 using skill outcome logic 116, the application command and resource data 108, and player interactions with one or more application user interfaces 112 of the interactive application.

In some embodiments, the interactive application 110 is a skill-based interactive application. In such embodiments, execution of the skill-based interactive application 110 by the interactive controller 102 is based on one or more players' skillful interaction with the interactive application 110, such as, but not limited to, the players' utilization of the interactive elements of the interactive application during the players' skillful interaction with the skill-based interactive application. In such an embodiment, the process controller 104 communicates with the interactive controller 102 in order to allow the coupling of the skill-based interactive application to random outcomes determined in accordance with a chance-based wager proposition of the wager subcontroller 136.

In some embodiments, the interactive application 110 uses skill proposition data, interactive application command data, and/or resource data included in the application commands and resources 108 to generate a skill proposition presented to one or more players as one or more application user interfaces 112 using one or more output devices of user interface and output device(s) 114. The one or more players skillfully interact with the one or more application user interfaces 112 using one or more of input devices of the user interface input and output devices 114. The interactive application 110 determines a skill outcome based on the skillful interactions of the one or more players and communicates data of the determined skill outcome to the process controller 104 as part of the application telemetry 106. In some embodiments, the interactive application 110 also communicates as part of the application telemetry data 106, data encoding the one or more players' interactions with the interactive application 110.

In some embodiments, the skill outcome logic 116 and the skill proposition data included in the application commands and resources 108 are for a skill proposition for one or more players. The interactive application 110 determines skill outcomes based on the skill proposition and the one or more players' skillful interactions with the interactive application. The skill outcomes are communicated by the interactive controller 102 to the process controller 104 included in the application telemetry 106.

In some embodiments, the interactive controller 102 includes one or more sensors that sense various aspects of the physical environment of the interactive controller 102. Examples of sensors include, but are not limited to: global positioning sensors (GPSs) for sensing communications from a GPS system to determine a position or location of the interactive controller; temperature sensors; accelerometers; pressure sensors; and the like. Sensor telemetry data is communicated by the interactive controller to the process controller 104 as part of the application telemetry data 106. The process controller 104 receives the sensor telemetry data and uses the sensor telemetry data to make wagering decisions.

In many embodiments, the interactive controller 102 includes one or more wagering user interfaces 118 used to display wagering data, via one or more of the user interface input and output devices 114, to one or more players.

In various embodiments, an application control interface 122 resident in the interactive controller 102 provides an interface between the interactive controller 102 and the process controller 104.

In some embodiments, the application control interface 122 implements an interactive controller to process controller communication protocol employing an interprocess communication protocol so that the interactive controller and the process controller may be implemented on the same device. In operation, the application control interface 122 provides application programming interfaces that are used by the interactive application 110 of the interactive controller 102 to communicate outgoing data and receive incoming data by passing parameter data to another process or application.

In some embodiments, the application control interface 122 implements an interactive controller to process controller communication protocol employing an interdevice communication protocol so that the interactive controller and the process controller may be implemented on different devices. The interdevice protocol may utilize a wired communication bus or wireless connection as a physical layer.

In various embodiments, the application control interface 122 implements an interactive controller to process controller communication protocol employing a networking protocol so that the interactive controller and the process controller may be implemented on different devices connected by a network. The networking protocol may utilize a wired communication bus or wireless connection as a physical layer. In many such embodiments, the network includes a cellular telephone network or the like and the interactive controller is a mobile device such as a smartphone or other device capable of using the telephone network. During operation, the application control interface 122 communicates outgoing data to an external device by encoding the data into a signal and transmitting the signal to an external device. The application control interface receives incoming data from an external device by receiving a signal transmitted by the external device and decoding the signal to obtain the incoming data.

The process controller 104 provides an interface between a skill proposition resolved for one or more players when skillfully interacting with the interactive application 110 provided by the interactive controller 102, and one or more random outcomes, provided in-part by a wager subcontroller 136.

In various embodiments, the process controller 104 includes a wager subcontroller 136 having a rule-based decision engine that receives application telemetry data 106 from the interactive controller 102. The rule-based decision engine has paired wagering proposition logic 130 including skill proposition logic 132 and random outcome logic 134. The decision engine uses the application telemetry data 106, along with random outcome logic 134, and a random outcome generated by one or more random number generators (RNGs) 138 to generate one or more random outcomes of a paired wagering proposition.

In some embodiments, the random outcome logic 134 includes one or more paytables that may be used to determine a random outcome based on one or more random outcomes from one or more random number generators. A wager subcontroller uses the one or more paytables to map the one or more random outcomes to a random outcome. The one or more paytables are used to implement one or more chance-based wager propositions in conjunction with one or more random outcomes of the one or more random number generators.

In an embodiment, the application telemetry data 106 used by the decision engine encodes data about the operation of the interactive application 110 executed by the interactive controller 102.

In some embodiments, the application telemetry data 106 encodes interactions of a player, such as a player's interaction with an interactive element of the interactive application 110.

In many embodiments, the application telemetry data 106 includes a state of the interactive application 110, such as values of variables that change as the interactive application 110 executes.

In several embodiments, the decision engine includes one or more rules as part of the random outcome logic 134 used by the decision engine 122 to determine how a random outcome should generated. Each rule includes one or more variable values constituting a pattern that is to be matched by the wager subcontroller 136 using the decision engine to one or more variable values encoded in the application telemetry data 106. Each rule also includes one or more actions that are to be taken if the pattern is matched. Actions can include automatically generating the random outcome in accordance with the random outcome logic 134 and a random outcome generated by one or more random number generators 138.

During operation, the decision engine receives application telemetry data 106 from the interactive controller 102 via interface 160. The decision engine performs a matching process of matching the variable values encoded in the application telemetry data 106 to one or more variable patterns of one or more rules. If a match between the variable values and a pattern of a rule is determined, then the wagering controller 104 performs the action of the matched rule.

In some embodiments, the wager subcontroller 136 uses the random outcome in conjunction with the application telemetry data 106 and skill proposition logic 132, to automatically generate application command and resource data 108 including skill proposition data of a paired wagering proposition that the process controller 104 communicates to the interactive controller 102 via interfaces 124 and 122.

In some embodiments, the decision engine includes one or more rules as part of skill proposition logic 132 used by the decision engine to automatically generate the application command and resource data 108 that is then communicated to the interactive controller 102. Each rule includes one or more variable values constituting a pattern that is to be matched to one or more variable values encoded in the application telemetry data 106 and the random outcome. Each rule also includes one or more actions that are to be automatically taken by the wager subcontroller 136 if the pattern is matched. Actions can include automatically generating skill proposition data, interactive application command data, and/or resource data 108 and using the skill proposition data, interactive application command data, and/or resource data 108 to control the interactive controller 102 to affect execution of the interactive application 110 as described herein. In operation, wager subcontroller 104 uses the decision engine 122 to match the variable values encoded in the in the random outcome data to one or more patterns of one or more rules of the skill proposition logic 132. If a match between the variable values and a pattern of a rule is found, then the process controller automatically performs the action of the matched rule. In some embodiments, the process controller 104 uses the application telemetry data 106 received from the interactive controller 102 in conjunction with the random outcome to generate the skill proposition data, interactive application command data, and/or resource data 108.

The interactive controller receives the skill proposition data, interactive application command data, and resource data 108 and automatically uses the skill proposition data, interactive application command data, and/or resource data 108 to configure and command the processes of the interactive application 110.

In some embodiments, the interactive application 110 operates utilizing a scripting language. The interactive application 110 parses scripts written in the scripting language and executes commands encoded in the scripts and sets variable values as defined in the scripts. In operation of such embodiments, the process controller 104 automatically generates skill proposition data, interactive application command data, and/or resource data 108 in the form of scripts written in the scripting language that are communicated to the interactive controller 102 during execution of the interactive application 110. The interactive controller 102 receives the scripts and passes them to the interactive application 110. The interactive application 110 receives the scripts, parses the scripts and automatically executes the commands and sets the variable values as encoded in the scripts.

In many embodiments, the interactive application 110 automatically performs processes as instructed by commands communicated from the process controller 104. The commands command the interactive application 110 to perform specified operations such as executing specified commands and/or setting the values of variables utilized by the interactive application 110. In operation of such embodiments, the process controller 104 automatically generates commands that are encoded into the skill proposition data, interactive application command data, and/or resource data 108 that are communicated to the interactive controller 102. The interactive controller 102 passes the skill proposition data, interactive application command data, and/or resource data 108 to the interactive application 110. The interactive application parses the skill proposition data, interactive application command data, and/or resource data and automatically performs operations in accordance with the commands encoded in the skill proposition data, interactive application command data, and/or resource data 108.

In many embodiments, the process controller 104 includes a pseudo random or random outcome generator used to generate random outcomes that are used by the decision engine to generate portions of the skill proposition data, interactive application command data, and/or resource data 108.

In various embodiments, the process controller 104 includes one or more interfaces, 124, 126 and 128 that operatively connect the process controller 104 to one or more interactive controllers, such as interactive controller 102, and to one or more credit processing systems, such as credit processing system 105.

In some embodiments, one or more of the process controller interfaces implement a process controller to device or server communication protocol employing an interprocess communication protocol so that the process controller and one or more of an interactive controller, a wager subcontroller, and/or a session sub-controller may be implemented on the same device. In operation, the process controller interfaces provide application programming interfaces or the like that are used by the process controller to communicate outgoing data and receive incoming data by passing parameter data to another process or application running on the same device.

In some embodiments, one or more of the process controller interfaces implement a process controller communication protocol employing an interdevice communication protocol so that the process controller may be implemented on a device separate from the one or more interactive controllers, the one or more session sub-controllers and/or the one or more wager subcontrollers. The interdevice protocol may utilize a wired communication bus or wireless connection as a physical layer. In various embodiments, one or more of the process controller interfaces implement a process controller communication protocol employing a networking protocol so that the process controller may be operatively connected to the one or more interactive controllers, the one or more session sub-controllers, and/or the one or more wager subcontrollers by a network. The networking protocol may utilize a wired communication bus or wireless connection as a physical layer. In many such embodiments, the network includes a cellular telephone network or the like and the one or more interactive controllers include a mobile device such as a smartphone or other device capable of using the telephone network. During operation, the one or more process controller interfaces communicate outgoing data to an external device or server by encoding the data into a signal and transmitting the signal to the external device or server. The one or more process controller interfaces receive incoming data from an external device or server by receiving a signal transmitted by the external device or server and decoding the signal to obtain the incoming data.

In several embodiments, the wager subcontroller 136 is a controller for providing one or more chance-based wagers in accordance with one or more chance-based wager propositions provided by the adaptive wagering system 100. Types of value of a wager can be one or more of several different types. Types of value of a wager can include, but are not limited to, a wager of an amount of credits corresponding to a real currency or a virtual currency, a wager of an amount of application credits earned through interaction with an interactive application, a wager of an amount of interactive elements of an interactive application, and a wager of an amount of objects used in an interactive application.

In various embodiments, a skill outcome determined for a wager in accordance with a skill proposition can increase or decrease an amount of the type of value used in the wager, such as, but not limited to, increasing or decreasing an amount of credits for a wager of credits. In various embodiments, a skill outcome determined for a wager in accordance with a skill proposition can increase or decrease an amount of a type of value that is different than a type of value of the wager, such as, but not limited to, increasing an amount of an object of an interactive application for a wager of credits.

In many embodiments, the process controller 104 includes one or more random number generators (RNGs) 138 for generating random outcomes. The wager subcontroller uses the one or more random outcomes along with the random outcome logic 130 to generate a random outcome in accordance with a chance-based of a paired wagering proposition.

In several embodiments, the process controller 104 includes a metering sub-controller 140 operatively connected to the credit processing system 105 via interfaces 126 and 128. The metering sub-controller 140 communicates with the credit processing system 105 to receive incoming credit data from the credit processing system 105. The metering sub-controller 140 uses the incoming credit data to transfer credits into the adaptive wagering system and onto one or more credit meters 142. The metering sub-controller 140 communicates outgoing credit data to the credit processing system 105 to transfer credits off of the one or more credit meters 142 and out of the adaptive wagering system.

In several embodiments, during operation, the metering sub-controller 140 communicates with the credit processing system 105 to receive incoming credit data from the credit processing system 105 and adds credits onto the one or more credit meters 110 at least partially on the basis of the incoming credit data. The one or more random number generators 138 execute processes that generate random outcomes. The wager subcontroller 136 uses the random outcome logic 134 and the random outcomes to generate a random outcome of a paired wagering proposition. The wager subcontroller uses the random outcome along with the skill proposition logic 132 to generate a skill proposition. The skill proposition is communicated by the process controller as part of the application command and resource data 108 to the interactive controller 102. The interactive application 110 uses the skill proposition data along with the skill outcome logic 116 to generate a presentation for the use including the one or more user interfaces 112. One or more players interact with the one or more application user interfaces 112 through the one or more user interface input and output devices 114. The interactive application 110 determines a skill outcome based on the interactions of the one or more players and communicates data of the skill outcome as part of the application telemetry data 106 to the process controller 104. The wagering sub controller 136 receives the skill outcome data and instructs the metering sub-controller 140 to add credits to, or deduct credits from, the one or more credit meters 110 based in part on the skill outcome data. For example, in some embodiments, the metering sub-controller is instructed to add an amount of credits to a credit meter of the one or more credit meters 110 when the skill outcome indicates a win for a player associated with the credit meter. In various embodiments, the metering sub-controller is instructed to deduct an amount of credits from the credit meter when the skill outcome indicates a loss for the player. At an end of a wagering session, the metering sub-controller 140 transfers credits off of the one or more credit meters 110 and out of the adaptive wagering system by communicating outgoing credit data to the credit processing system 105.

In many embodiments, the one or more random number generators 138 generate random numbers by continuously generating pseudo random numbers using a pseudo random number generator. A most current pseudo random number is stored in a buffer thus constantly refreshing the buffer. In some embodiments, the buffer is refreshed at a rate exceeding 100 times per second. When the wager subcontroller 136 requests a random outcome, the wager subcontroller 136 receives the stored most current pseudo random number from the buffer. As timing between requests for a random outcome is not deterministic, the resulting output from the buffer is a random outcome such as a random number.

In many embodiments, the random outcome is used along with a paytable that the wager subcontroller selects from one or more paytables. The selected paytable includes a mapping of values in a range of values of the random outcome to specified multipliers to be applied to an amount of wagered credits to determine a random outcome as an amount of credits to be added to one or more credit meters associated with the chance-based wager proposition. A multiplier is selected from the paytable based on the random outcome and the selected multiplier is used along with an amount of credits wagered to determine a random outcome as an amount of credits.

In some embodiments, a range of the value of a random outcome is mapped to one or more symbols representing one or more elements of a traditional chance-based wager proposition. In several such embodiments, a random outcome is mapped to a virtual card of a deck of virtual cards. In another such embodiment, the random outcome is mapped to a virtual face of a virtual die. In yet another such embodiment, the random outcome is mapped to symbol of a virtual reel strip on a virtual reel slot machine. In yet another such embodiment, the random outcome is mapped to a pocket of a virtual roulette wheel. In some embodiments, two or more random outcomes are mapped to appropriate symbols to represent a completed chance-based wager proposition. In one such embodiment, two or more random outcomes are mapped to faces of two or more virtual dice to simulate a random outcome generated by throwing two or more dice. In another such embodiment, multiple random outcomes are mapped to virtual cards from a virtual deck of cards without replacement. In yet another such embodiment, two or more random outcomes are mapped to two or more virtual reel strips to create stop positions for a virtual multi-reel slot machine.

In some embodiments, a wager subcontroller determines a random outcome by executing proposition determination commands included in random outcome logic that define processes of a paired wagering proposition where the proposition determination commands are formatted in a scripting language. In operation, a decision engine of a process controller generates the proposition determination commands in the form of a script written in the scripting language. The script includes the proposition determination commands that describe how the wager subcontroller is to generate a random outcome. The wager subcontroller parses the script encoded in the chance-based wager proposition determination command data and executes the commands included in the script to generate the random outcome.

In some embodiments, a wager subcontroller determines a random outcome by executing proposition determination commands that define processes of the wagering user interface. In operation, a decision engine of a process controller generates the proposition determination commands. The wager subcontroller receives the proposition determination commands and executes the proposition determination commands to generate the random outcome.

In various embodiments, the process controller 104 uses a rule-based decision engine to automatically determine an amount of application credits to award to a player based at least in part on the application telemetry data 106 including skill outcome data and player interaction data with the interactive application 110 of the adaptive wagering system. In numerous embodiments, the interactive application 110 is a skill-based interactive application and the application credits are awarded for a player's skillful interaction with the interactive application 110.

In some embodiments, the wager subcontroller 136 uses a wagering user interface generator 148 to automatically generate wagering telemetry data 150 on the basis of amounts of credits on the one or more credit meters 142. The wagering telemetry data 150 is used by the process controller 104 to command the interactive controller 102 to automatically generate one or more wagering user interfaces 152 describing a state of wagered credit accumulation and loss for the adaptive wagering system. When a player interacts with the one or more wagering user interfaces 152, wagering user interface telemetry data 150 is generated by the one or more wagering user interfaces 152 and communicated by the interactive controller 102 to the process controller 104 using interfaces 122 and 124.

In some embodiments, the wagering telemetry data 150 may include, but is not limited to, amounts of application credits and interactive elements earned, lost or accumulated through interaction with the interactive application 110, and credits, application credits and interactive elements amounts awarded, lost or accumulated.

In some embodiments, the skill proposition data, interactive application command data, and/or resource data 108 are communicated to the wagering user interface generator 148 and used as a partial basis for generation of the wagering telemetry data 150 communicated to the interactive controller 102.

In various embodiments, the wagering user interface generator 148 also receives random outcome data that is used as a partial basis for generation of the wagering telemetry data 150 communicated to the interactive controller 102. In some embodiments, the random outcome data also includes data about one or more states of a wager of the chance-based wager proposition as generated by the wager subcontroller 136. In various such embodiments, the wagering user interface generator 148 generates a random outcome generation process display and/or random outcome state display using the one or more states of the random outcome. The random outcome generation process display and/or random outcome state display is included in the wagering telemetry data 150 that is communicated to the interactive controller 102. The wagering process display and/or wagering state display is automatically displayed by the interactive controller 102 using the one or more wagering user interfaces 152. In other such embodiments, the one or more states of the random outcome are communicated to the interactive controller 102 and the interactive controller 102 is instructed to automatically generate the random outcome generation process display and/or random outcome state display of the one or more wagering user interfaces 152 using the one or more states of the random outcome for display.

In some embodiments, the random outcome includes state data about execution of a chance-based wager proposition of the random outcome logic 134, including but not limited to a final state, intermediate state and/or beginning state of the chance-based wager proposition. For example, in a chance-based wager proposition that is based on slot machine math, the final state of the chance-based wager proposition may be reel positions, in a chance-based wager proposition that is based on roulette wheel math, the final state may be a pocket where a ball may have come to rest, in a chance-based wager proposition that is a based on card math, the beginning, intermediate and final states may represent a sequence of cards being drawn from a deck of cards, etc.

In some embodiments, an interactive controller generates a wagering user interface by executing commands that define processes of the wagering user interface where the commands are formatted in a scripting language. In operation, a wagering user interface generator of a process controller generates commands in the form of a script written in the scripting language. The script includes commands that describe how the interactive controller is to display wagering outcome data. The completed script is encoded as wagering telemetry data and communicated to the interactive controller by the process controller. The interactive controller receives the wagering telemetry data and parses the script encoded in the wagering telemetry data and executes the commands included in the script to generate the wagering user interface.

In many embodiments, an interactive controller generates a wagering user interface based on a document written in a document markup language that includes commands that define processes of the wagering user interface. In operation, a wagering user interface generator of a process controller generates a document composed in the document markup language. The document includes commands that describe how the interactive controller is to display wagering outcome data. The completed document is encoded as wagering telemetry data and communicated to the interactive controller by the process controller. The interactive controller receives the wagering telemetry data and parses the document encoded in the wagering telemetry data and executes the commands encoded into the document to generate the wagering user interface.

In some embodiments, an interactive controller generates a wagering user interface by executing commands that define processes of the wagering user interface. In operation, a wagering user interface generator of a process controller generates the commands and encodes the commands into wagering telemetry data that is communicated to the interactive controller by the process controller. The interactive controller receives the wagering telemetry data and executes the commands encoded in the wagering telemetry data to generate the wagering user interface.

In various embodiments, an interactive controller includes a data store of graphic and audio display resources that the interactive controller uses to generate a wagering user interface as described herein.

In many embodiments, a process controller communicates graphic and audio display resources as part of wagering telemetry data to an interactive controller. The interactive controller uses the graphic and audio display resources to generate a wagering user interface as described herein.

In many embodiments, the process controller 104 may additionally include various audit logs and activity meters.

The process controller 104 can further operatively connect to a metering sub-controller to determine an amount of credit or interactive elements available and other wagering metrics of a paired wagering proposition. Thus, the process controller 104 may potentially affect an amount of credits in play for participation in the wagering events of the paired wagering proposition provided by the wager subcontroller. In some embodiments, the process controller 104 can also couple to a centralized server for exchanging various data related to players and the activities of the players during utilization of an adaptive wagering system.

In a number of embodiments, communication of random outcome determination commands between the wager subcontroller 136 and the process controller 104 can further be used to communicate various wagering control factors that the wager subcontroller uses as input. Examples of wagering control factors include, but are not limited to, an amount of credits, amount of application credits, amount of interactive elements, or amounts of objects consumed wager, and/or a player's election to enter a jackpot round.

In many embodiments, two or more players can be engaged in using the interactive application 110 executed by the interactive controller 102. In various embodiments, an adaptive wagering system can include an interactive application 110 that provides a skill-based interactive application that includes head-to-head play between a single player and a computing device, between two or more players against one another, or multiple players playing against a computer device and/or each other. In some embodiments, the interactive application 110 can be a skill-based interactive application where the player is not skillfully playing against the computer or any other player such as skill-based interactive applications where the player is effectively skillfully playing against himself or herself.

In some embodiments, the process controller 104 utilizes the one or more wagering user interfaces 152 to communicate certain interactive application data to the player, including but not limited to, club points, player status, control of the selection of choices, and messages which a player can find useful in order to adjust the interactive application experience or understand the wagering status of the player.

In some embodiments, the process controller 104 utilizes the one or more wagering user interfaces 152 to communicate aspects of a paired wagering proposition to a player including, but not limited to, amount of credits, application credits, interactive elements, or objects in play, and amounts of credits, application credits, interactive elements, or objects available.

In a number of embodiments, the wager subcontroller 136 can accept paired wagering proposition factors including, but not limited to, modifications in the amount of credits, application credits, interactive elements, or objects wagered on each individual wagering event, entrance into a bonus round, and other factors. In several embodiments, the process controller 104 can communicate a number of factors back and forth to the wager subcontroller, such that an increase/decrease in a wagered amount can be related to the change in player profile of the player in the interactive application. In this manner, a player can control a wager amount per wagering event in accordance with the paired wagering proposition with the change mapping to a parameter or component that is applicable to the interactive application experience.

In some embodiments, the process controller 104 includes a session sub-controller 154 is used to regulate an adaptive wagering system session.

In various embodiments, the session sub-controller 154 includes one or more session sub-controller interfaces that operatively connect the session sub-controller 154 to one or more wager subcontrollers, metering sub-controllers and pooled bet sub-controllers through their respective interfaces.

In some embodiments, one or more of the session sub-controller interfaces implement a session sub-controller to device or server communication protocol employing an interprocess communication protocol so that the session sub-controller and one or more of an interactive controller, a wager subcontroller, and/or a process controller may be implemented on the same device. In operation, the session sub-controller interfaces provide application programming interfaces or the like that are used by the session sub-controller to communicate outgoing data and receive incoming data by passing parameter data to another process or application running on the same device.

In some embodiments, one or more of the session sub-controller interfaces implement a session sub-controller communication protocol employing an interdevice communication protocol so that the session sub-controller may be implemented on a device separate from the one or more interactive controllers, the one or more process controllers and/or the one or more wager subcontrollers. The interdevice protocol may utilize a wired communication bus or wireless connection as a physical layer. In various embodiments, one or more of the session sub-controller interfaces implement a session sub-controller communication protocol employing a networking protocol so that the process session sub-controller may be operatively connected to the one or more interactive controllers, the one or more process controllers, and/or the one or more wager subcontrollers by a network. The networking protocol may utilize a wired communication bus or wireless connection as a physical layer. In many such embodiments, the network includes a cellular telephone network or the like and the one or more interactive controllers include a mobile device such as a smartphone or other device capable of using the telephone network. During operation, the one or more session sub-controller interfaces communicate outgoing data to an external device or server by encoding the data into a signal and transmitting the signal to the external device or server. The one or more session sub-controller interfaces receive incoming data from an external device or server by receiving a signal transmitted by the external device or server and decoding the signal to obtain the incoming data.

In various embodiments, components of the process controller 104 communicate session data to the session sub-controller. The session data may include, but is not limited to, player data, interactive controller data, pooled bet and side bet data, process controller data and wager subcontroller data used by the session sub-controller to regulate an adaptive wagering system session.

In some embodiments, the session sub-controller 154 may also assert control of an adaptive wagering system session by communicating session control data to components of the process controller 104. Such control may include, but is not limited to, commanding the process controller 104 to end an adaptive wagering system session, initiating wagering in an adaptive wagering system session, ending wagering in an adaptive wagering system session but not ending a player's use of the interactive application portion of the adaptive wagering system, and changing from real credit wagering in an adaptive wagering system to virtual credit wagering, or vice versa.

In many embodiments, the session sub-controller 154 manages player profiles for a plurality of players. The session sub-controller 154 stores and manages data about players in order to provide authentication and authorization of players of the adaptive wagering system 100. In some embodiments, the session sub-controller 154 also manages geolocation information to ensure that the adaptive wagering system 100 is only used by players in jurisdictions were wagering is approved. In various embodiments, the session sub-controller 154 stores application credits that are associated with the player's use of the interactive application of the adaptive wagering system 100.

In some embodiments, the session sub-controller 154 communicates player and session management data to the player using a management user interface (not shown) of the interactive controller. The player interacts with the management user interface and the management user interface generates management telemetry data that is communicated to the session sub-controller 154 via interfaces 122 and 124.

In some embodiments, the wager subcontroller 136 communicates wagering session data to the session sub-controller 154. In various embodiments, the session sub-controller communicates wagering session control data to the wager subcontroller 136.

In many embodiments, an adaptive wagering system includes a skill bonus controller 190 operatively connected to a process controller 104 via one or more interfaces. The skill bonus controller includes skill bonus outcome allocation rules 192 for allocating a skill bonus outcome of credits to a player when the process controller 104 requests that the skill bonus outcome be generated. The skill bonus controller further includes one or more skill bonus pool credit meters 194 for storing data about one or more pools of skill bonus credits that are available to provide to player as a skill bonus outcome. The skill bonus controller further includes a skill bonus database 196 for storing data about skill bonus pools of credits. In some embodiments, the skill bonus controller supports a plurality of types of skill-based games provided by one or more interactive applications, such as interactive application 110. In many embodiments, the database is used to store data of skill scores of player's skillful play of a skill-based game provided the interactive application 110. In various embodiments, the database further stores data of wagering metrics of players' wagering when using the adaptive wagering system.

In some embodiments, a process controller operates as an interface between an interactive controller and a wager subcontroller. By virtue of this construction, the wager subcontroller is isolated from the interactive controller allowing the interactive controller to operate in an unregulated environment while allowing the wager subcontroller to operate in a regulated environment.

In some embodiments, a single wager subcontroller may provide services to two or more interactive controllers and/or two or more process controllers, thus allowing an adaptive wagering system to operate over a large range of scaling.

In various embodiments, multiple types of interactive controllers using different operating systems may be interfaced to a single type of process controller and/or wager subcontroller without requiring customization of the process controller and/or the wager subcontroller.

In many embodiments, an interactive controller may be provided as a player device under control of a player while maintaining the wager subcontroller in an environment under the control of a regulated operator of wagering equipment.

In several embodiments, data communicated between the controllers may be encrypted to increase security of the adaptive wagering system.

In some embodiments, a process controller isolates random outcome logic and skill proposition logic as unregulated logic from a regulated wager subcontroller, thus allowing errors in the skill proposition logic and/or random outcome logic to be corrected, new skill proposition logic and/or random outcome logic to be used, or modifications to be made to the skill proposition logic and/or random outcome logic without a need for regulatory approval.

In various embodiments, an interactive application may require extensive processing resources from an interactive controller leaving few processing resources for the functions performed by a process controller and/or a wager subcontroller. By virtue of the architecture described herein, processing loads may be distributed across multiple devices such that operations of the interactive controller may be dedicated to the interactive application and the processes of the process controller and/or wager subcontroller are not burdened by the requirements of the interactive application.

In many embodiments, an adaptive wagering system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like.

In some embodiments, one or more components of an adaptive wagering system are distributed in close proximity to each other and communicate using a local area network and/or a communication bus. In several embodiments, an interactive controller and a process controller of an adaptive wagering system are in a common location and communicate with an external wager subcontroller. In some embodiments, a process controller and a wager subcontroller of an adaptive wagering system are in a common location and communicate with an external interactive controller. In many embodiments, an interactive controller, a process controller, and a wager subcontroller of an adaptive wagering system are located in a common location. In some embodiments, a session sub-controller is located in a common location with a process controller and/or a wager subcontroller.

In various embodiments, these multiple devices can be constructed from or configured using a single device or a plurality of devices such that an adaptive wagering system is executed as a system in a virtualized space such as, but not limited to, where a wager subcontroller and a process controller are large scale centralized servers in the cloud operatively connected to widely distributed interactive controllers via a wide area network such as the Internet or a local area network. In such embodiments, the components of an adaptive wagering system may communicate using a networking protocol or other type of device-to-device communications protocol.

In some embodiments, an adaptive wagering system is deployed over a local area network or a wide area network in an interactive configuration. An interactive configuration of an adaptive wagering system includes an interactive controller operatively connected by a network to a process controller and a wager subcontroller.

In some embodiments, an adaptive wagering system is deployed over a local area network or a wide area network in a mobile configuration. A mobile configuration of an adaptive wagering system is useful for deployment over wireless communication network, such as a wireless local area network or a wireless telecommunications network. A mobile configuration of an adaptive wagering system includes an interactive controller operatively connected by a wireless network to a process controller and a wager subcontroller.

In several embodiments, a centralized process controller is operatively connected to one or more interactive controllers and one or more wager subcontrollers using a communication link. The centralized process controller can perform the functionality of a process controller across various adaptive wagering systems.

In numerous embodiments, an interactive application server provides a host for managing head-to-head play operating over a network of interactive controllers connected to the interactive application server using a communication link. The interactive application server provides an environment where players can compete directly with one another and interact with other players.

<Credit Processing System>

In many embodiments, the credit processing system 105 operatively connects to one or more credit input devices for generating incoming credit data from a credit input. Credit inputs can include, but are not limited to, credit items used to transfer credits. The incoming credit data are communicated by the credit processing system 105 to the metering sub-controller 140. In various embodiments, the one or more credit input devices and their corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validator and/or coin validators that receive and validate paper and/or coin currency or tokens.

In various embodiments, the credit processing system 105 includes one or more credit output devices 146 for generating a credit output based on outgoing credit data 192 communicated from the wager subcontroller. Credit outputs can include, but are not limited to, credit items used to transfer credits. Types of credit output devices and their corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing system 105 is operatively connected to, and communicates with, a TITO controller or the like to determine incoming credit data representing amounts of credits to be transferred into the adaptive wagering system and to determine outgoing credit data representing amounts of credits to be transferred out of the adaptive wagering system. In operation, the credit processing system 105 communicates with a connected credit input device, such as a bill validator/ticket scanner, used to scan a credit input in the form of a TITO ticket having indicia of credit account data of a credit account of the TITO controller. The credit processing system 105 communicates the credit account data to the TITO controller. The TITO controller uses the credit account data to determine an amount of credits to transfer to the credit processing system 105, and thus to the metering sub-controller 140 of the process controller 104. The TITO controller communicates the amount of credits to the credit processing system 105. The credit processing system 105 communicates the amount of credits as incoming credit data to the metering sub-controller 140 and the metering sub-controller 140 credits one or more credit meters 142 with the amount of credits so that the credits can be used when a player makes wagers using the adaptive wagering system 100.

In many embodiments, the credit processing system 105 is operatively connected to a bill validator/ticket scanner as one of the one or more credit input devices 144. The credit processing system 105 communicates with the bill validator/ticket scanner to scan currency used as a credit input to determine an amount of credits as incoming credit data to transfer credit to one or more credit meters 110 associated with one or more players. The skill metering sub-controller 140 credits the one or more credit meters 110 with the amount of credits so that the credits can be used when a player makes wagers using the adaptive wagering system 100.

In some embodiments, the credit processing system 105 can use a TITO controller along with a ticket or voucher printer as one of the one or more credit output devices 146 to generate a TITO ticket as a credit output for a player. In operation, the credit processing system 105 communicates, as outgoing credit data, data of an amount of credits to be credited to a credit account on the TITO controller. The TITO controller receives the amount of credits and creates the credit account and credits the credit account with the amount of credits. The TITO controller generates credit account data for the credit account and communicates the credit account data to the credit processing system 105. The credit processing system 105 uses the ticket or voucher printer to print indicia of the credit account data onto a TITO ticket or voucher as a credit output.

In various embodiments, a credit processing interface 156 resident in the credit processing system 105 provides an interface between the credit processing system 156 and the process controller 104.

In some embodiments, the application control interface 122 implements a credit processing system to process controller communication protocol employing an interprocess communication protocol so that the interactive controller 104 and the credit processing system 105 may be implemented on the same device. In operation, the credit processing interface 156 provides application programming interfaces that are used by the credit processing system 105 to communicate outgoing data and receive incoming data by passing parameter data to another process or application.

In some embodiments, the credit processing interface 156 implements an interactive controller to credit processing system communication protocol employing an interdevice communication protocol so that the interactive controller and the credit processing system may be implemented on different devices. The interdevice protocol may utilize a wired communication bus or wireless connection as a physical layer.

In various embodiments, the credit processing interface 156 implements an interactive controller to credit processing system communication protocol employing a networking protocol so that the interactive controller 104 and the credit processing system 105 may be implemented on different devices connected by a network. The networking protocol may utilize a wired communication bus or wireless connection as a physical layer. During operation, the credit processing interface 156 communicates outgoing data to an external device by encoding the data into a signal and transmitting the signal to an external device. The application control interface receives incoming data from an external device by receiving a signal transmitted by the external device and decoding the signal to obtain the incoming data.

In various embodiments, the credit processing system 105 provides an interface to an electronic payment management system (not shown) such as an electronic wallet or the like. The electronic payment system provides credit account data that is used for generating incoming credit data as a credit input and outgoing credit data as a credit output.

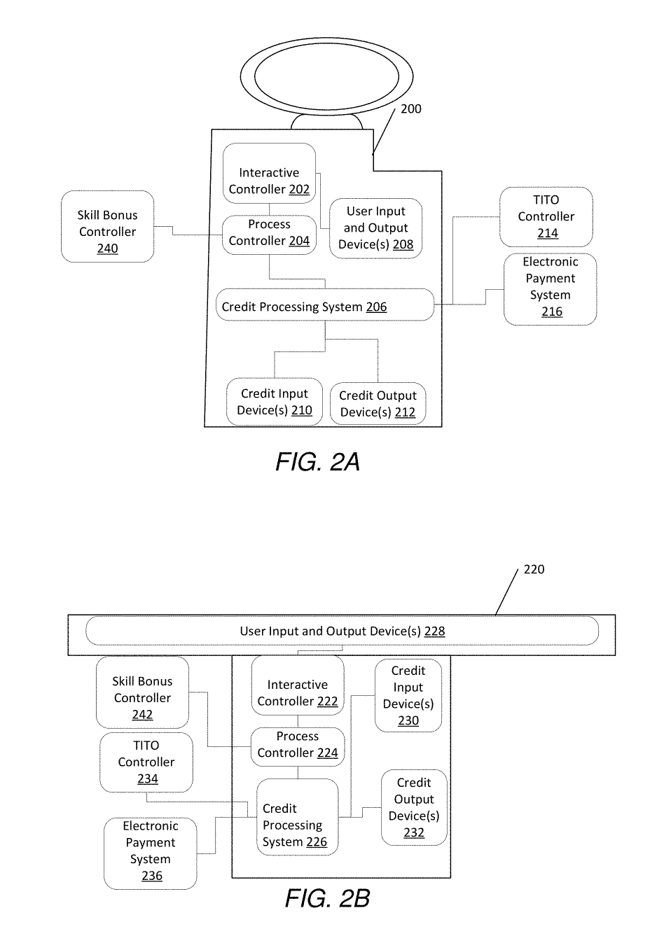

FIG. 2A is a diagram of an electronic gaming machine configuration of an adaptive wagering system in accordance with various embodiments of the invention. Electronic gaming machine configurations of an adaptive wagering system include, but are not limited to, electronic gaming machines such as slot machines, table games, video arcade consoles and the like. An electronic gaming machine configuration of an adaptive wagering system 200 includes an interactive controller 202, a process controller 204 and a credit processing system 206 contained in an enclosure such as a housing, cabinet, casing or the like. The enclosure may further include one or more player accessible openings or surfaces that may be used to mount one or more player accessible user input devices and user output devices 208, one or more player accessible credit input devices 210 and one or more credit output devices 212. The interactive controller 202 communicates with the user input devices to detect player interactions with the adaptive wagering system and commands and controls the user output devices to provide a user interface to one or more players of the adaptive wagering system as described herein. The process controller 204 communicates with the credit processing system 206 or player credit processing devices 210 and 212 to transfer credits into and out of the adaptive wagering system as described herein.

In many embodiments, the process controller 204 is operatively connected to an external session sub-controller (not shown). The session sub-controller may provide session control for a wagering session or may provide services for management of a player account for the storage of player points, application credits and the like.

In various embodiments, the process controller 204 is operatively connected to the credit processing system 206. In many embodiments, the credit processing system 206 is operatively connected to one or more credit input devices 210 for generating incoming credit data from a credit input as described herein. The incoming credit data are communicated to the process controller 204. In various embodiments, the one or more credit input devices and their corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validators and/or coin validators that receive and validate paper and/or coin currency or tokens.

In various embodiments, the credit processing system 206 is operatively connected to the one or more credit output devices 212 for generating a credit output based on outgoing credit data communicated from the process controller 204. Credit outputs can include, but are not limited to, credit items used to transfer credits. Types of credit output devices and their corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing system 206 is operatively connected to, and communicates with, a TITO controller 214 or the like to determine incoming credit data representing amounts of credits to be transferred into the adaptive wagering system 200 and to determine outgoing credit data representing amounts of credits to be transferred out of the adaptive wagering system 200. In operation, the credit processing system 206 communicates with one of the one or more connected credit input devices 210, such as a bill validator/ticket scanner, used to scan a credit input in the form of a TITO ticket having indicia of credit account data of a credit account of the TITO controller 214. The credit processing system 206 communicates the credit account data to the TITO controller 214. The TITO controller 214 uses the credit account data to determine an amount of credits to transfer to the credit processing system 206 of the adaptive wagering system 200. The TITO controller 214 communicates the amount of credits to the credit processing system 206. The credit processing system 206 communicates the amount of credits as incoming credit data to the process controller 204 which credits one or more credit meters with the amount of credits so that the credits can be used when a player makes wagers using the adaptive wagering system 200.

In many embodiments, the credit processing system 206 includes a bill validator/ticket scanner as one of the one or more credit input devices 210. The credit processing system 206 communicates with the bill validator/ticket scanner to scan currency used as a credit input to determine an amount of credits as incoming credit data to transfer credit to one or more credit meters associated with one or more players. The process controller 204 credits the one or more credit meters with the amount of credits so that the credits can be used when a player makes wagers using the adaptive wagering system 200.

In some embodiments, the credit processing system 206 can use the TITO controller 214 along with a ticket or voucher printer as one of the one or more credit output devices 212 to generate a TITO ticket as a credit output for a player. In operation, the credit processing system 206 communicates, as outgoing credit data, data of an amount of credits to be credited to a credit account on the TITO controller 214. The TITO controller 214 receives the amount of credits and creates the credit account and credits the credit account with the amount of credits. The TITO controller 214 generates credit account data for the credit account and communicates the credit account data to the credit processing system 206. The credit processing system 206 uses the ticket or voucher printer to print indicia of the credit account data onto a TITO ticket as a credit output.

In various embodiments, the credit processing system 206 provides an interface to an electronic payment system 216 such an electronic wallet or the like. The electronic payment system 216 provides credit account data that is used for generating incoming credit data as a credit input and outgoing credit data as a credit output.

In some embodiments, the process controller 204 is operatively connected to a central determination controller (not shown). In operation, when a wager subcontroller of the process controller 204 needs to determine a random outcome, the wager subcontroller communicates a request to the central determination controller for the random outcome. The central determination controller receives the random outcome request and generates a random outcome in response to the random outcome request. The central determination controller communicates data of the random outcome to the process controller 204. The processing controller 204 receives the data of the random outcome and utilizes the random outcome as described herein. In some embodiments, the random outcome is drawn from a pool of pre-determined random outcomes.

In various embodiments, the wagering process controller 204 may be operatively connected to a skill bonus controller 240 along with one or more other process controllers of one or more other adaptive wagering systems. The skill bonus controller provides services for the collection and provision of credits used by the process controller 204 to provide random outcomes that have a skill bonus pooling component.

FIG. 2B is a diagram of multiplayer electronic gaming machine configuration of an adaptive wagering system in accordance with various embodiments of the invention. Types of a multiplayer electronic gaming machine configuration an adaptive wagering system include, but are not limited to, multiplayer electronic gaming machines, multiplayer slot machines, multiplayer table gaming devices, multi player video arcade consoles and the like. A multiplayer electronic gaming machine configuration of an adaptive wagering system 220 includes an interactive controller 222, a process controller 224 and a credit processing system 226 contained in an enclosure such as a housing, cabinet, casing or the like. The enclosure may further include one or more player accessible openings or surfaces that may be used to mount one or more player accessible user input devices and user output devices 228, one or more player accessible credit input devices 230 and one or more player accessible credit output devices 212.

In some embodiments, two or more sets of credit input devices and credit output devices are provided so that each player of the multiplayer electronic gaming machine configuration of an adaptive wagering system 220 can have an associated set of credit input devices and credit output devices.

The interactive controller 222 communicates with the user input devices to detect player interactions with the adaptive wagering system and commands and controls the user output devices to provide a user interface to one or more players of the adaptive wagering system as described herein. The process controller 224 communicates with the credit processing system 226 or player credit processing devices 230 and 232 to transfer credits into and out of the adaptive wagering system as described herein.

In many embodiments, the process controller 224 is operatively connected to an external session sub-controller (not shown). The session sub-controller may provide session control for a wagering session or may provide services for management of a player account for the storage of player points, application credits and the like.

In various embodiments, the process controller 224 is operatively connected to the credit processing system 226. In many embodiments, the credit processing system 226 is operatively connected to one or more credit input devices 230 for generating incoming credit data from a credit input as described herein. The incoming credit data are communicated to the process controller 224. In various embodiments, the one or more credit input devices and their corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validators and/or coin validators that receive and validate paper and/or coin currency or tokens.

In various embodiments, the credit processing system 226 is operatively connected to the one or more credit output devices 232 for generating a credit output based on outgoing credit data communicated from the process controller 224. Credit outputs can include, but are not limited to, credit items used to transfer credits. Types of credit output devices and their corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing system 226 is operatively connected to, and communicates with, a TITO controller 234 or the like to determine incoming credit data representing amounts of credits to be transferred into the adaptive wagering system 220 and to determine outgoing credit data representing amounts of credits to be transferred out of the adaptive wagering system 220. In operation, the credit processing system 226 communicates with one of the one or more connected credit input devices 230, such as a bill validator/ticket scanner, used to scan a credit input in the form of a TITO ticket having indicia of credit account data of a credit account of the TITO controller 234. The credit processing system 226 communicates the credit account data to the TITO controller 234. The TITO controller 234 uses the credit account data to determine an amount of credits to transfer to the credit processing system 226 of the adaptive wagering system 220. The TITO controller 234 communicates the amount of credits to the credit processing system 226. The credit processing system 226 communicates the amount of credits as incoming credit data to the process controller 224 which credits one or more credit meters with the amount of credits so that the credits can be used when a player makes wagers using the adaptive wagering system 220.

In many embodiments, the credit processing system 226 includes a bill validator/ticket scanner as one of the one or more credit input devices 230. The credit processing system 226 communicates with the bill validator/ticket scanner to scan currency used as a credit input to determine an amount of credits as incoming credit data to transfer credit to one or more credit meters associated with one or more players. The process controller 224 credits the one or more credit meters with the amount of credits so that the credits can be used when a player makes wagers using the adaptive wagering system 220.

In some embodiments, the credit processing system 226 can use the TITO controller 234 along with a ticket or voucher printer as one of the one or more credit output devices 232 to generate a TITO ticket as a credit output for a player. In operation, the credit processing system 226 communicates, as outgoing credit data, data of an amount of credits to be credited to a credit account on the TITO controller 234. The TITO controller 234 receives the amount of credits and creates the credit account and credits the credit account with the amount of credits. The TITO controller 234 generates credit account data for the credit account and communicates the credit account data to the credit processing system 226. The credit processing system 226 uses the ticket or voucher printer to print indicia of the credit account data onto a TITO ticket as a credit output.

In various embodiments, the credit processing system 226 provides an interface to an electronic payment system 236 such an electronic wallet or the like.

The electronic payment system 236 provides credit account data that is used for generating incoming credit data as a credit input and outgoing credit data as a credit output.

In some embodiments, the process controller 224 is operatively connected to a central determination controller (not shown). In operation, when a wager subcontroller of the process controller 224 needs to determine a random outcome, the wager subcontroller communicates a request to the central determination controller for the random outcome. The central determination controller receives the random outcome request and generates a random outcome in response to the random outcome request. The central determination controller communicates data of the random outcome to the process controller 224. The processing controller 224 receives the data of the random outcome and utilizes the random outcome as described herein. In some embodiments, the random outcome is drawn from a pool of pre-determined random outcomes.

In various embodiments, the wagering process controller 224 may be operatively connected to a skill bonus controller 242 along with one or more other process controllers of one or more other adaptive wagering systems. The skill bonus controller provides services for the collection and provision of credits used by the process controller 224 to provide random outcomes that have a skill bonus pooling component.

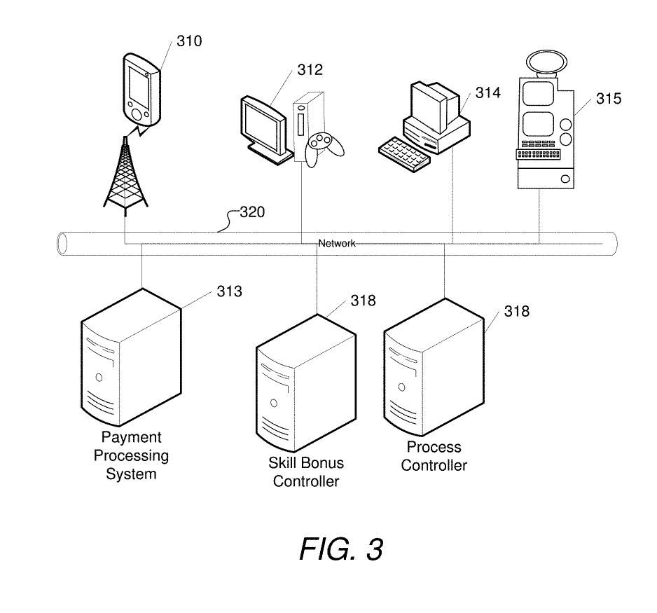

FIG. 3 is a diagram of distributed adaptive wagering systems in accordance with various embodiments of the invention. An interactive controller, such as interactive controller 102 of FIG. 1, may be constructed from or configured using one or more processing devices that perform the operations of the interactive controller. An interactive controller in a distributed adaptive wagering system may be constructed from or configured using any processing device having sufficient processing and communication capabilities that may be that perform the processes of an interactive controller in accordance with various embodiments of the invention. In some embodiments, the construction or configuration of the interactive controller may be achieved through the use of an application control interface, such as application control interface 122 of FIG. 1, and/or through the use of an interactive application, such as interactive application 110 of FIG. 1.

In some embodiments, an interactive controller may be constructed from or configured using an electronic gaming machine 315, such as a slot machine or the like. The electronic gaming machine 315 may be physically located in various types of gaming establishments.

In many embodiments, an interactive controller may be constructed from or configured using a portable device 310. The portable device 310 is a device that may wirelessly connect to a network. Examples of portable devices include, but are not limited to, a tablet computer, a personal digital assistant, and a smartphone.

In some embodiments, an interactive controller may be constructed from or configured using a gaming console 312.

In various embodiments, an interactive controller may be constructed from or configured using a personal computer 314.

In some embodiments, one or more processing devices, such as devices 310, 312, 314 and 315, may be used to construct a complete adaptive wagering system and may be operatively connected using a communication link to a session and/or management controller.

Some adaptive wagering systems in accordance with many embodiments of the invention can be distributed across a plurality of devices in various configurations. One or more interactive controllers of a distributed adaptive wagering system, such as but not limited to, a mobile or wireless device 310, a gaming console 312, a personal computer 314, and an electronic gaming machine 315, are operatively connected with a process controller 318 of a distributed adaptive wagering system using a communication link 320. Communication link 320 is a communications link that allows processing systems to communicate with each other and to share data. Embodiments of a communication link include, but are not limited to: a wired or wireless interdevice communication link; a serial or parallel interdevice communication bus; a wired or wireless network such as a Local Area Network (LAN), a Wide Area Network (WAN), or the link; or a wired or wireless communication network such as a wireless telecommunications network or plain old telephone system (POTS). In some embodiments, one or more processes of an interactive controller and a process controller as described herein are executed on the individual interactive controllers 310, 312, 314 and 315 while one or more processes of a process controller as described herein can be executed by the process controller 318.

In many embodiments, a distributed adaptive wagering system and may be operatively connected using a communication link to a session controller (not shown), that performs the processes of a session controller as described herein.

In several embodiments, a distributed adaptive wagering system and may be operatively connected using a communication link to credit processing system 311, that performs the processes of one or more credit processing systems as described herein.

In various embodiments, one or more distributed adaptive wagering systems may be operatively connected to a skill bonus controller 320. The skill bonus controller provides services for the collection and provision of credits used to provide random outcomes that have a skill bonus pooling component.

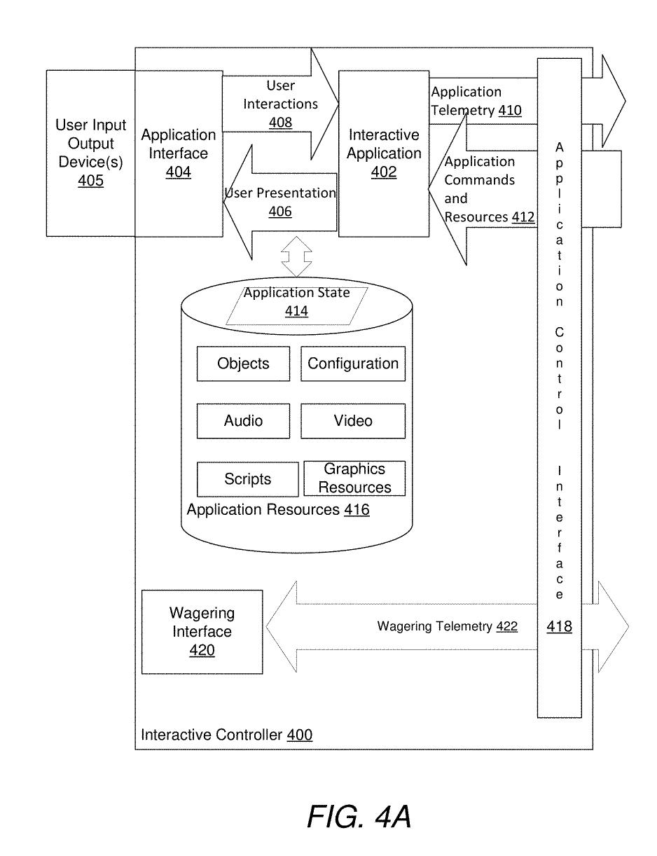

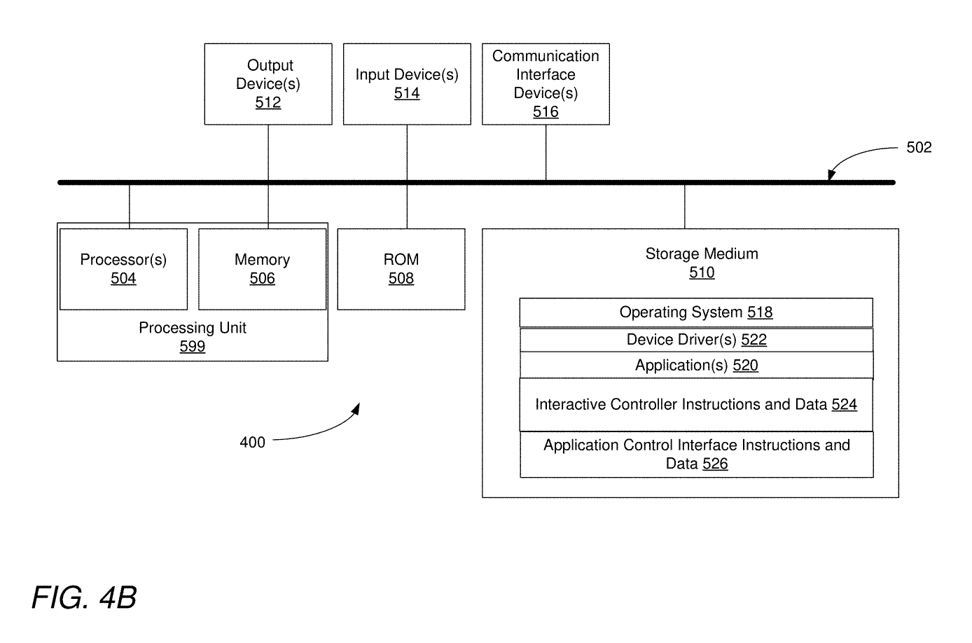

Referring now to FIG. 4A, an interactive controller 400, suitable for use as interactive controller 102 of FIG. 1, provides an execution environment for an interactive application 402 of an adaptive wagering system. In several embodiments, an interactive controller 400 of an adaptive wagering system provides an interactive application 402 that generates an application interface 404 for interaction with by a player. The interactive application 402 generates a player presentation 406 that is presented to the player through the application interface 404 using one or more player input and output devices 405. The player presentation 406 may include audio features, visual features or tactile features, or any combination of these features. In various embodiments, the application interface 404 utilizes one or more user interface input and output devices 405 so that a player can interact with the player presentation 406. In various embodiments, user interface input devices include, but are not limited to: buttons or keys; keyboards; keypads; game controllers; joysticks; computer mice; track balls; track buttons; touch pads; touch screens; accelerometers; motion sensors; video input devices; microphones; and the like. In various embodiments, user interface output devices include, but are not limited to: audio output devices such as speakers, headphones, earbuds, and the like; visual output devices such as lights, video displays and the like; and tactile devices such as rumble pads, hepatic touch screens, buttons, keys and the like. The player's interactions 408 are included by the interactive application 402 in application telemetry data 410 that is communicated by interactive controller 400 to various other components of an adaptive wagering system as described herein. The interactive application 402 receives application commands and resources 412 communicated from various other components of an adaptive wagering system as described herein. In some embodiments, the application telemetry data 410 may include player interactions with objects of the interactive application and a skill outcome for a skill proposition presented to the player by the interactive application 402.

In some embodiments, various components of the interactive application 402 can read data from an application state 414 in order to provide one or more features of the interactive application. In various embodiments, components of the interactive application 402 can include, but are not limited to: a physics engine; a rules engine; an audio engine; a graphics engine and the like. The physics engine is used to simulate physical interactions between virtual objects in the interactive application 402. The rules engine implements the rules of the interactive application and a random number generator that may be used for influencing or determining certain variables and/or outcomes to provide a randomizing influence on the operations of the interactive application. The graphics engine is used to generate a visual representation of the interactive application state to the player. The audio engine is used to generate an audio representation of the interactive application state to the player.

During operation, the interactive application reads and writes application resources 416 stored on a data store of the interactive controller host. The application resources 416 may include objects having graphics and/or control logic used to provide application environment objects of the interactive application. In various embodiments, the resources may also include, but are not limited to, video files that are used to generate a portion of the player presentation 406; audio files used to generate music, sound effects, etc. within the interactive application; configuration files used to configure the features of the interactive application; scripts or other types of control code used to provide various features of the interactive application; and graphics resources such as textures, objects, etc. that are used by a graphics engine to render objects displayed in an interactive application.

In operation, components of the interactive application 402 read portions of the application state 414 and generate the player presentation 406 for the player that is presented to the player using the user interface 404. The player perceives the player presentation and provides player interactions 408 using the user input devices. The corresponding player interactions are received as player actions or inputs by various components of the interactive application 402. The interactive application 402 translates the player actions into interactions with the virtual objects of the application environment stored in the application state 414. Components of the interactive application use the player interactions with the virtual objects of the interactive application and the interactive application state 414 to update the application state 414 and update the player presentation 406 presented to the player. The process loops continuously while the player interacts with the interactive application of the adaptive wagering system.

The interactive controller 400 provides one or more interfaces 418 between the interactive controller 400 and other components of an adaptive wagering system, such as, but not limited to, a process controller. The interactive controller 400 and the other adaptive wagering system components communicate with each other using the interface. The interface may be used to pass various types of data, and to communicate and receive messages, status data, commands and the like. In certain embodiments, the interactive controller 400 and a process controller communicate application commands and resources 412 and application telemetry data 410. In some embodiments, the communications include requests by the process controller that the interactive controller 400 update the application state 414 using data provided by the process controller.

In many embodiments, communications between a process controller and the interactive controller 400 includes a request that the interactive controller 400 update one or more resources 416 using data provided by the process controller. In a number of embodiments, the interactive controller 400 provides all or a portion of the application state to the process controller. In some embodiments, the interactive controller 400 may also provide data about one or more of the application resources 416 to the process controller. In some embodiments, the communication includes player interactions that the interactive controller 400 communicates to the process controller. The player interactions may be low level player interactions with the user interface 404, such as manipulation of an input device, or may be high level interactions with game objects as determined by the interactive application. The player interactions may also include resultant actions such as modifications to the application state 414 or game resources 416 resulting from the player's interactions taken in the adaptive wagering system interactive application. In some embodiments, player interactions include, but are not limited to, actions taken by entities such as non-player characters (NPC) of the interactive application that act on behalf of or under the control of the player.

In various embodiments, the application commands and resources 412 include skill proposition application commands and/or resources used by the interactive application to generate a presentation of a skill proposition presented to a player and to determine a skill outcome based on the player's skillful interaction with the presentation of the skill proposition.

In some embodiments, the interactive controller 400 includes a wagering user interface 420 used to provide adaptive wagering system telemetry data 422 to and from the player. The adaptive wagering system telemetry data 422 from the adaptive wagering system includes, but is not limited to, data used by the player to configure credit, application credit and interactive element wagers, and data about the chance-based wager proposition credits, application credits and interactive element wagers such as, but not limited to, credit, application credit and interactive element balances and credit, application credit and interactive element amounts wagered.

In some embodiments, the interactive controller includes one or more sensors (not shown). Such sensors may include, but are not limited to, physiological sensors that monitor the physiology of the player, environmental sensors that monitor the physical environment of the interactive controller, accelerometers that monitor changes in motion of the interactive controller, and location sensors that monitor the location of the interactive controller such as global positioning sensors (GPSs). The interactive controller 400 communicates sensor telemetry data to one or more components of the adaptive wagering system.

Referring now to FIG. 4B, interactive controller 400 includes a bus 502 that provides an interface for one or more processors 504, random access memory (RAM) 506, read only memory (ROM) 508, machine-readable storage medium 510, one or more user output devices 512, one or more user input devices 514, and one or more communication interface devices 516.

The one or more processors 504 may take many forms, such as, but not limited to: a central processing unit (CPU); a multi-processor unit (MPU); an ARM processor; a controller; a programmable logic device; or the like.

In the example embodiment, the one or more processors 504 and the random access memory (RAM) 506 form an interactive controller processing unit 599. In some embodiments, the interactive controller processing unit includes one or more processors operatively connected to one or more of a RAM, ROM, and machine-readable storage medium; the one or more processors of the interactive controller processing unit receive instructions stored by the one or more of a RAM, ROM, and machine-readable storage medium via a bus; and the one or more processors execute the received instructions. In some embodiments, the interactive controller processing unit is an ASIC (Application-Specific Integrated Circuit). In some embodiments, the interactive controller processing unit is a SoC (System-on-Chip).

Examples of output devices 512 include, but are not limited to, display screens; light panels; and/or lighted displays. In accordance with particular embodiments, the one or more processors 504 are operatively connected to audio output devices such as, but not limited to: speakers; and/or sound amplifiers. In accordance with many of these embodiments, the one or more processors 504 are operatively connected to tactile output devices like vibrators, and/or manipulators.

Examples of user input devices 514 include, but are not limited to: tactile devices including but not limited to, keyboards, keypads, foot pads, touch screens, and/or trackballs; non-contact devices such as audio input devices; motion sensors and motion capture devices that the interactive controller can use to receive inputs from a player when the player interacts with the interactive controller; physiological sensors that monitor the physiology of the player; environmental sensors that monitor the physical environment of the interactive controller; accelerometers that monitor changes in motion of the interactive controller; and location sensors that monitor the location of the interactive controller such as global positioning sensors.

The one or more communication interface devices 516 provide one or more wired or wireless interfaces for communicating data and commands between the interactive controller 400 and other devices that may be included in an adaptive wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS) interface, a cellular or satellite telephone network interface; and the like.

The machine-readable storage medium 510 stores machine-executable instructions for various components of the interactive controller, such as but not limited to: an operating system 518; one or more device drivers 522; one or more application programs 520 including but not limited to an interactive application; and adaptive wagering system interactive controller instructions and data 524 for use by the one or more processors 504 to provide the features of an interactive controller as described herein. In some embodiments, the machine-executable instructions further include application control interface/application control interface instructions and data 526 for use by the one or more processors 504 to provide the features of an application control interface/application control interface as described herein.

In various embodiments, the machine-readable storage medium 510 is one of a (or a combination of two or more of) a hard drive, a flash drive, a DVD, a CD, a flash storage, a solid state drive, a ROM, an EIEPROM, and the like.

In operation, the machine-executable instructions are loaded into memory 506 from the machine-readable storage medium 510, the ROM 508 or any other storage location. The respective machine-executable instructions are accessed by the one or more processors 504 via the bus 502, and then executed by the one or more processors 504. Data used by the one or more processors 504 are also stored in memory 506, and the one or more processors 504 access such data during execution of the machine-executable instructions. Execution of the machine-executable instructions causes the one or more processors 504 to control the interactive controller 400 to provide the features of an adaptive wagering system interactive controller as described herein

Although the interactive controller is described herein as being constructed from or configured using one or more processors and instructions stored and executed by hardware components, the interactive controller can be constructed from or configured using only hardware components in accordance with other embodiments. In addition, although the storage medium 510 is described as being operatively connected to the one or more processors through a bus, those skilled in the art of interactive controllers will understand that the storage medium can include removable media such as, but not limited to, a USB memory device, an optical CD ROM, magnetic media such as tape and disks. In some embodiments, the storage medium 510 can be accessed by the one or more processors 504 through one of the communication interface devices 516 or using a communication link. Furthermore, any of the user input devices or user output devices can be operatively connected to the one or more processors 504 via one of the communication interface devices 516 or using a communication link.

In some embodiments, the interactive controller 400 can be distributed across a plurality of different devices. In many such embodiments, an interactive controller of an adaptive wagering system includes an interactive application server operatively connected to an interactive client using a communication link. The interactive application server and interactive application client cooperate to provide the features of an interactive controller as described herein.

In various embodiments, the interactive controller 400 may be used to construct other components of an adaptive wagering system as described herein.

In some embodiments, components of an interactive controller and a process controller of an adaptive wagering system may be constructed from or configured using a single device using processes that communicate using an interprocess communication protocol. In other such embodiments, the components of an interactive controller and a process controller of an adaptive wagering system may communicate by passing messages, parameters or the like.

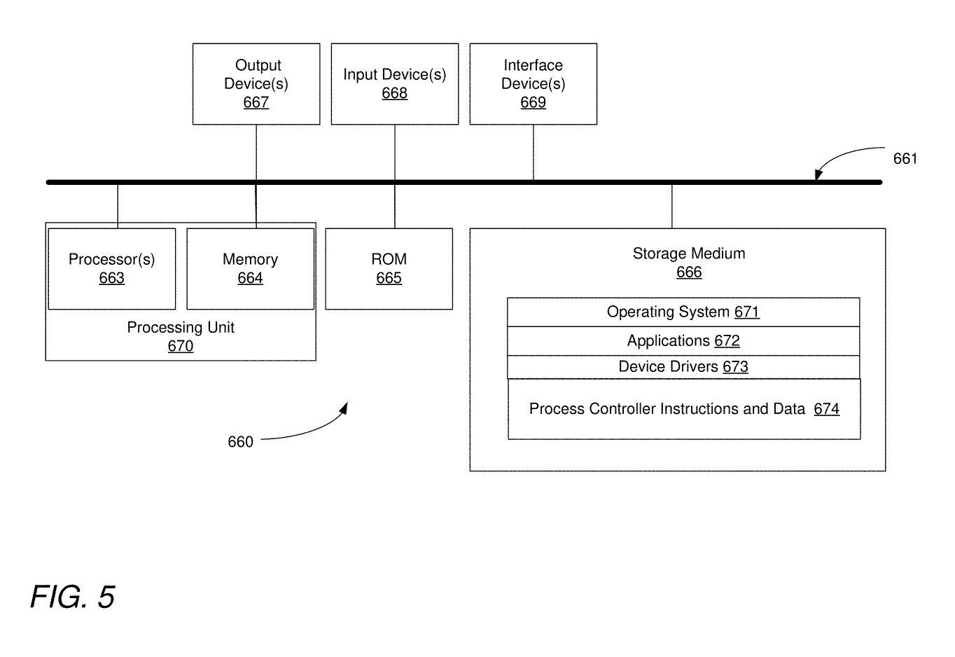

FIG. 5 is a diagram of a structure of a process controller, suitable for use as process controller 104 of FIG. 1, of an adaptive wagering system in accordance with various embodiments of the invention. A process controller may be constructed from or configured using one or more processing devices that perform the operations of the process controller. In many embodiments, a process controller can be constructed from or configured using various types of processing devices including, but not limited to, a mobile device such as a smartphone, a personal digital assistant, a wireless device such as a tablet computer or the like, an electronic gaming machine such as a slot machine, a personal computer, a gaming console, a set-top box, a computing device, a controller, a server, or the like.

Process controller 660 includes a bus 661 providing an interface for one or more processors 663, random access memory (RAM) 664, read only memory (ROM) 665, machine-readable storage medium 666, one or more user output devices 667, one or more user input devices 668, and one or more communication interface and/or network interface devices 669.

The one or more processors 663 may take many forms, such as, but not limited to: a central processing unit (CPU); a multi-processor unit (MPU); an ARM processor; a programmable logic device; or the like.

Examples of output devices 667 include, include, but are not limited to: display screens; light panels; and/or lighted displays. In accordance with particular embodiments, the one or more processors 663 are operatively connected to audio output devices such as, but not limited to: speakers; and/or sound amplifiers. In accordance with many of these embodiments, the one or more processors 663 are operatively connected to tactile output devices like vibrators, and/or manipulators.

In the example embodiment, the one or more processors 663 and the random access memory (RAM) 664 form a process controller processing unit 670. In some embodiments, the process controller processing unit includes one or more processors operatively connected to one or more of a RAM, ROM, and machine-readable storage medium; the one or more processors of the process controller processing unit receive instructions stored by the one or more of a RAM, ROM, and machine-readable storage medium via a bus; and the one or more processors execute the received instructions. In some embodiments, the process controller processing unit is an ASIC (Application-Specific Integrated Circuit). In some embodiments, the process controller processing unit is a SoC (System-on-Chip).

Examples of user input devices 668 include, but are not limited to: tactile devices including but not limited to, keyboards, keypads, foot pads, touch screens, and/or trackballs; non-contact devices such as audio input devices; motion sensors and motion capture devices that the process controller can use to receive inputs from a player when the player interacts with the process controller 660.

The one or more communication interface and/or network interface devices 669 provide one or more wired or wireless interfaces for exchanging data and commands between the process controller 660 and other devices that may be included in an adaptive wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS), cellular, or satellite telephone network interface; and the like.

The machine-readable storage medium 666 stores machine-executable instructions for various components of the process controller 660 such as, but not limited to: an operating system 671; one or more applications 672; one or more device drivers 673; and adaptive wagering system process controller instructions and data 674 for use by the one or more processors 663 to provide the features of a process controller as described herein.

In various embodiments, the machine-readable storage medium 670 is one of a (or a combination of two or more of) a hard drive, a flash drive, a DVD, a CD, a flash storage, a solid state drive, a ROM, an EIEPROM, and the like.

In operation, the machine-executable instructions are loaded into memory 664 from the machine-readable storage medium 666, the ROM 665 or any other storage location. The respective machine-executable instructions are accessed by the one or more processors 663 via the bus 661, and then executed by the one or more processors 663. Data used by the one or more processors 663 are also stored in memory 664, and the one or more processors 663 access such data during execution of the machine-executable instructions. Execution of the machine-executable instructions causes the one or more processors 663 to control the process controller 660 to provide the features of an adaptive wagering system process controller as described herein.

Although the process controller 660 is described herein as being constructed from or configured using one or more processors and instructions stored and executed by hardware components, the process controller can be composed of only hardware components in accordance with other embodiments. In addition, although the storage medium 666 is described as being operatively connected to the one or more processors through a bus, those skilled in the art of process controllers will understand that the storage medium can include removable media such as, but not limited to, a USB memory device, an optical CD ROM, magnetic media such as tape and disks. Also, in some embodiments, the storage medium 666 may be accessed by processor 663 through one of the interfaces or using a communication link. Furthermore, any of the user input devices or user output devices may be operatively connected to the one or more processors 663 via one of the interfaces or using a communication link.

In various embodiments, the process controller 660 may be used to construct other components of an adaptive wagering system as described herein.

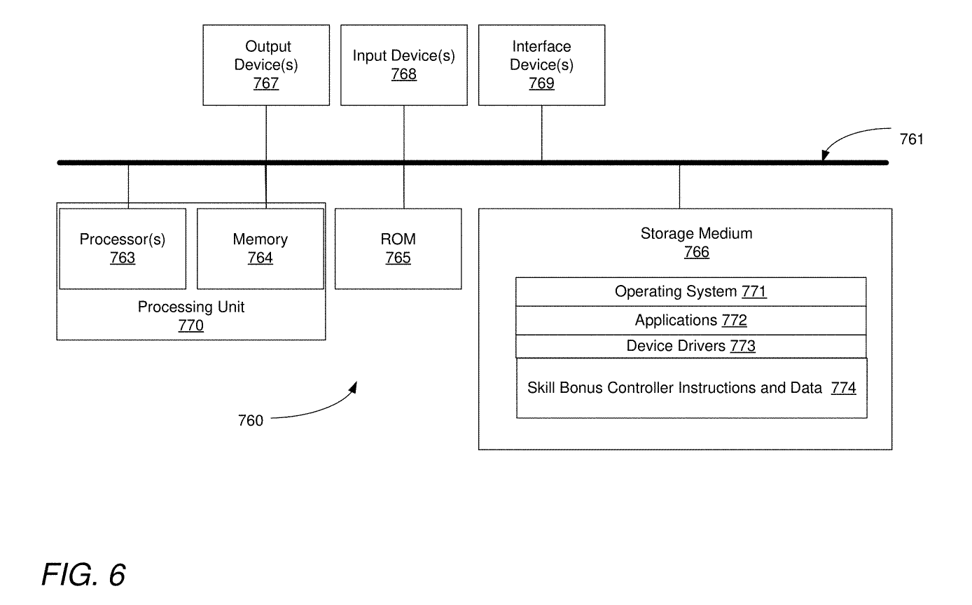

FIG. 6 is a diagram of a structure of a skill bonus controller, suitable for use as skill bonus controller of FIG. 1, of an adaptive wagering system in accordance with various embodiments of the invention. A skill bonus controller may be constructed from or configured using one or more processing devices that perform the operations of the skill bonus controller. In many embodiments, a skill bonus controller can be constructed from or configured using various types of processing devices including, but not limited to, a mobile device such as a smartphone, a personal digital assistant, a wireless device such as a tablet computer or the like, an electronic gaming machine such as a slot machine, a personal computer, a gaming console, a set-top box, a computing device, a controller, a server, or the like.

Skill bonus controller 760 includes a bus 761 providing an interface for one or more processors 763, random access memory (RAM) 764, read only memory (ROM) 765, machine-readable storage medium 766, one or more user output devices 767, one or more user input devices 768, and one or more communication interface and/or network interface devices 769.

The one or more processors 763 may take many forms, such as, but not limited to: a central processing unit (CPU); a multi-processor unit (MPU); an ARM processor; a programmable logic device; or the like.

Examples of output devices 767 include, include, but are not limited to: display screens; light panels; and/or lighted displays. In accordance with particular embodiments, the one or more processors 763 are operatively connected to audio output devices such as, but not limited to: speakers; and/or sound amplifiers. In accordance with many of these embodiments, the one or more processors 763 are operatively connected to tactile output devices like vibrators, and/or manipulators.

In the example embodiment, the one or more processors 763 and the random access memory (RAM) 764 form a skill bonus controller processing unit 770. In some embodiments, the skill bonus controller processing unit includes one or more processors operatively connected to one or more of a RAM, ROM, and machine-readable storage medium; the one or more processors of the skill bonus controller processing unit receive instructions stored by the one or more of a RAM, ROM, and machine-readable storage medium via a bus; and the one or more processors execute the received instructions. In some embodiments, the skill bonus controller processing unit is an ASIC (Application-Specific Integrated Circuit). In some embodiments, the skill bonus controller processing unit is a SoC (System-on-Chip).

Examples of user input devices 768 include, but are not limited to: tactile devices including but not limited to, keyboards, keypads, foot pads, touch screens, and/or trackballs; non-contact devices such as audio input devices; motion sensors and motion capture devices that the skill bonus controller can use to receive inputs from a player when the player interacts with the skill bonus controller 760.

The one or more communication interface and/or network interface devices 769 provide one or more wired or wireless interfaces for exchanging data and commands between the skill bonus controller 760 and other devices that may be included in an adaptive wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS), cellular, or satellite telephone network interface; and the like.

The machine-readable storage medium 766 stores machine-executable instructions for various components of the skill bonus controller 760 such as, but not limited to: an operating system 771; one or more applications 772; one or more device drivers 773; and skill bonus controller instructions and data 774 for use by the one or more processors 763 to provide the features of a skill bonus controller as described herein.

In various embodiments, the machine-readable storage medium 770 is one of a (or a combination of two or more of) a hard drive, a flash drive, a DVD, a CD, a flash storage, a solid state drive, a ROM, an EIEPROM, and the like.

In operation, the machine-executable instructions are loaded into memory 764 from the machine-readable storage medium 766, the ROM 765 or any other storage location. The respective machine-executable instructions are accessed by the one or more processors 763 via the bus 761, and then executed by the one or more processors 763. Data used by the one or more processors 763 are also stored in memory 764, and the one or more processors 763 access such data during execution of the machine-executable instructions. Execution of the machine-executable instructions causes the one or more processors 763 to control the skill bonus controller 760 to provide the features of an adaptive wagering system skill bonus controller as described herein.

Although the skill bonus controller 760 is described herein as being constructed from or configured using one or more processors and instructions stored and executed by hardware components, the skill bonus controller can be composed of only hardware components in accordance with other embodiments. In addition, although the storage medium 766 is described as being operatively connected to the one or more processors through a bus, those skilled in the art of skill bonus controllers will understand that the storage medium can include removable media such as, but not limited to, a USB memory device, an optical CD ROM, magnetic media such as tape and disks. Also, in some embodiments, the storage medium 766 may be accessed by processor 763 through one of the interfaces or using a communication link. Furthermore, any of the user input devices or user output devices may be operatively connected to the one or more processors 763 via one of the interfaces or using a communication link.

In various embodiments, the skill bonus controller 760 may be used to construct other components of an adaptive wagering system as described herein.

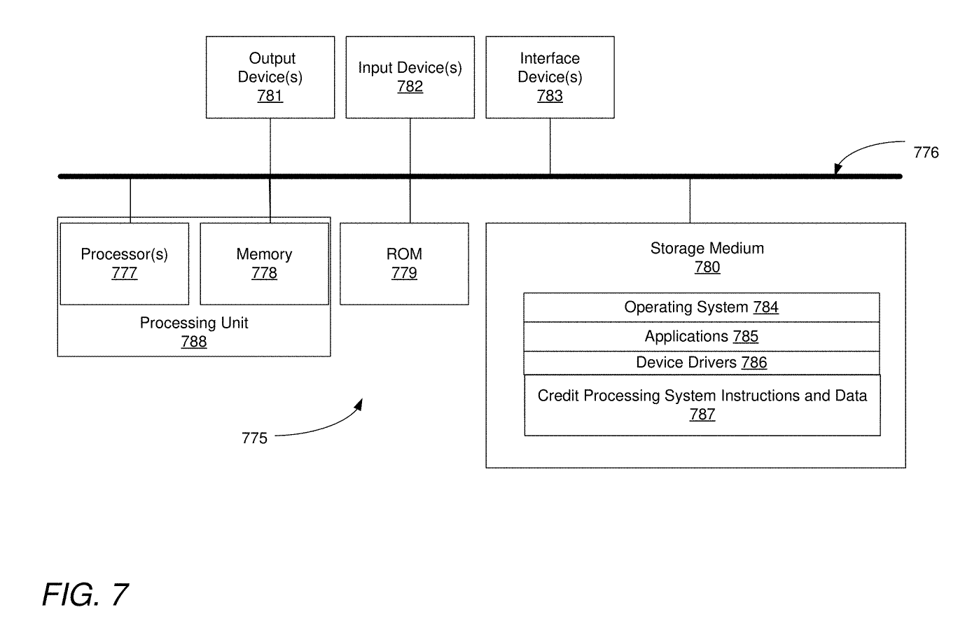

FIG. 7 is a diagram of a structure of a credit processing system, suitable for use as credit processing system 105 of FIG. 1, of an adaptive wagering system in accordance with various embodiments of the invention. A credit processing system may be constructed from or configured using one or more processing devices that perform the operations of the credit processing system. In many embodiments, a credit processing system can be constructed from or configured using various types of processing devices including, but not limited to, a mobile device such as a smartphone, a personal digital assistant, a wireless device such as a tablet computer or the like, an electronic gaming machine such as a slot machine, a personal computer, a gaming console, a set-top box, a computing device, a controller, a server, or the like.

Credit processing system 775 includes a bus 776 providing an interface for one or more processors 777, random access memory (RAM) 778, read only memory (ROM) 779, machine-readable storage medium 780, one or more user output devices 781, one or more user input devices 782, and one or more communication interface and/or network interface devices 783.

The one or more processors may take many forms, such as, but not limited to: a central processing unit (CPU); a multi-processor unit (MPU); an ARM processor; a programmable logic device; or the like.

Examples of output devices include, but are not limited to: display screens; light panels; lighted displays; credit item printers and writing devices; audio output devices such as, but not limited to, buzzers, speakers and sound amplifiers; and tactile output devices like vibrators, and/or manipulators.

In the example embodiment, the one or more processors and the random access memory (RAM) form a credit processing system processing unit 788. In some embodiments, the credit processing system processing unit includes one or more processors operatively connected to one or more of a RAM, ROM, and machine-readable storage medium; the one or more processors of the credit processing system processing unit receive instructions stored by the one or more of a RAM, ROM, and machine-readable storage medium via a bus; and the one or more processors execute the received instructions. In some embodiments, the credit processing system processing unit is an ASIC (Application-Specific Integrated Circuit). In some embodiments, the credit processing system processing unit is a SoC (System-on-Chip).

Examples of user input devices include, but are not limited to: credit item reading devices such as optical and/or electromagnetic scanners; tactile devices including but not limited to, keyboards, keypads, foot pads, touch screens, and/or trackballs; non-contact devices such as audio input devices; motion sensors and motion capture devices that the credit processing system can use to receive inputs from a player when the player interacts with the credit processing system.

The one or more communication interface and/or network interface devices provide one or more wired or wireless interfaces for exchanging data and commands between the credit processing system and other devices that may be included in an adaptive wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS), cellular, or satellite telephone network interface; and the like.

The machine-readable storage medium stores machine-executable instructions for various components of the credit processing system such as, but not limited to: an operating system 784; one or more applications 785; one or more device drivers 786; and credit processing system instructions and data 787 for use by the one or more processors 763 to provide the features of a credit processing system as described herein.

In various embodiments, the machine-readable storage medium is one of a (or a combination of two or more of) a hard drive, a flash drive, a DVD, a CD, a flash storage, a solid state drive, a ROM, an EIEPROM, and the like.

In operation, the machine-executable instructions are loaded into memory from the machine-readable storage medium, the ROM or any other storage location.

The respective machine-executable instructions are accessed by the one or more processors via the bus, and then executed by the one or more processors. Data used by the one or more processors are also stored in memory, and the one or more processors access such data during execution of the machine-executable instructions. Execution of the machine-executable instructions causes the one or more processors to control the credit processing system to provide the features of a credit processing system as described herein.

Although the credit processing system is described herein as being constructed from or configured using one or more processors and instructions stored and executed by hardware components, the credit processing system can be composed of only hardware components in accordance with other embodiments. In addition, although the storage medium is described as being operatively connected to the one or more processors through a bus, those skilled in the art of credit processing systems will understand that the storage medium can include removable media such as, but not limited to, a USB memory device, an optical CD ROM, magnetic media such as tape and disks. Also, in some embodiments, the storage medium may be accessed by the one or more processors through one of the interfaces or using a communication link. Furthermore, any of the user input devices or user output devices may be operatively connected to the one or more processors via one of the interfaces or using a communication link.

In various embodiments, the credit processing system may be used to construct other components of an adaptive wagering system as described herein.

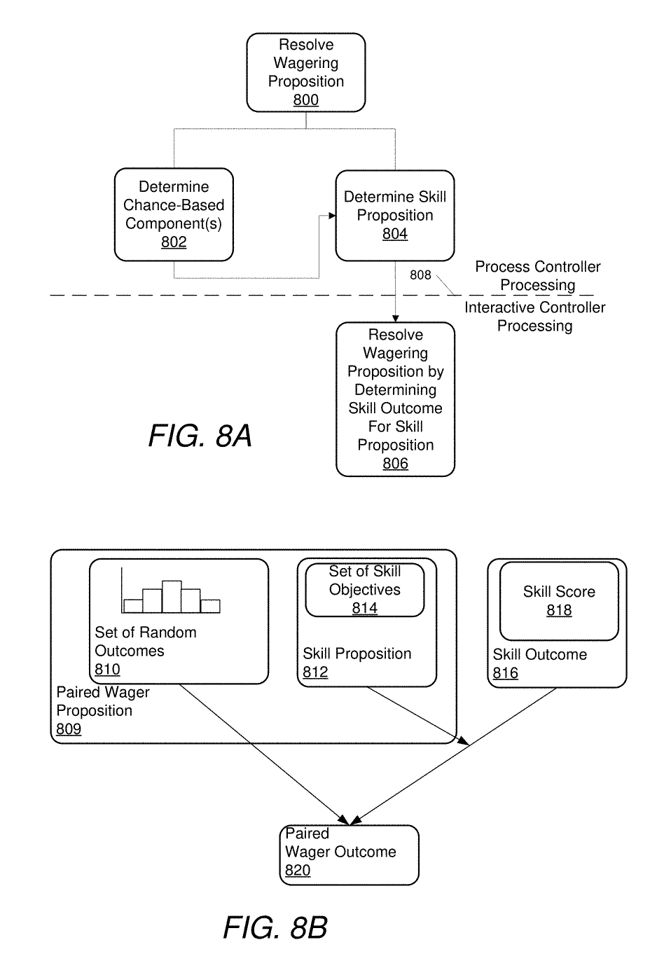

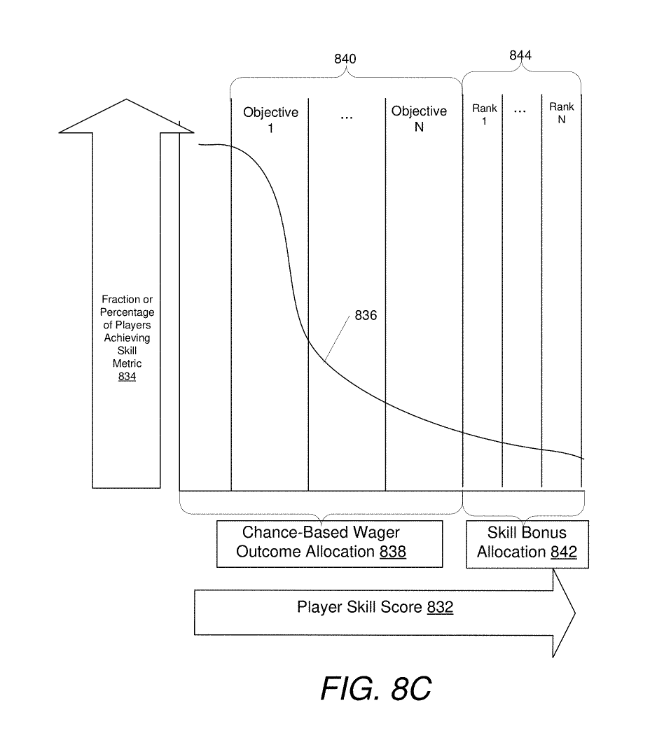

FIG. 8A is a block diagram of a process of an adaptive wagering system during a wagering session in accordance with various embodiments of the invention. An adaptive wagering system resolves 800 a wagering proposition by determining 802 a random outcome using one or more random outcomes. The random outcome is then used to determine 804 portions of a skill proposition that will be presented to one or more players. The wager is resolved 806 by determining a skill outcome for the skill proposition.

In some embodiments, as indicated by dashed line 808, a process controller of the adaptive wagering system performs processing for determining 802 the random outcome and determining 804 the skill proposition while an interactive controller performs processing for determining 806 the skill outcome.

FIG. 8B is a block diagram of a paired wagering proposition of an adaptive wagering system during a wagering session in accordance with various embodiments of the invention. A paired wagering proposition 809 includes a set of random outcomes 810 and a skill proposition 812 having a set of skill objectives 814 that correspond to the set of random outcomes 810.

During operation, an adaptive wagering system presents the skill proposition to a player as a set of skill objectives to be achieved by the player. Each member of the set of skill objectives is associated with a member of a set of random outcomes. The adaptive wagering system determines a skill outcome 812 for the skill proposition including skill score data describing the player's skill-based achievements achieved by the player 818 when presented with the skill proposition. A paired wager outcome 820 is determined by combining the skill outcome 816 with the set of random outcomes 810 to allocate the one or more of the random outcomes to the player on the basis of the player achieving one or more of the skill objectives as determined from the skill score data.

FIG. 8C is a diagram illustrating a paired wagering outcome in accordance with various embodiments of the invention. A paired wagering outcome of an individual player utilizes an individual skill score 832 of a player as compared to historical player skill score data 834 expressed as fraction or percentage of all players who have achieved a particular skill metric. The individual skill score is a value of a skill score for an individual player that is included in a skill outcome for the player. The skill score can be any metric that is used to score a player's skillful play of a skill-based game provided by an interactive application. Historical skill score data can be used to determine a probability 836 that any individual player will fall within a specified skill range, thus giving a cumulative probability for player scores. Chance-based components in the form of random outcomes are allocated 838 to a player as a paired wager outcome based on the player's individual skill score as compared to the skill score data collected from other players. As illustrated, one to N random outcomes are allocated 838 as an award awarded to the player depending on which of one to N chance-based skill ranges 840, expressed in the form of a plurality of skill objectives, that the player's individual skill score falls into. In addition, the player may be awarded a skill bonus that is allocated 842 to the player based on a ranking 844 of the player's individual skill score against the skill score one or more other players. Accordingly, a paired wagering outcome for a player may include credits awarded to the player based on the player's achievement of one or more skill objectives associated with one or more random outcomes that are determined using a paytable and a random number generator having an output of random outcomes that are uniformly distributed. Each of the one or more skill objectives correspond to a specified range of individual skill scores as compared to historical skill score data. In addition, the player may receive credits from a skill bonus allocated to the player based on the player's individual skill score falling with a specified range of individual skill score percentile rankings.

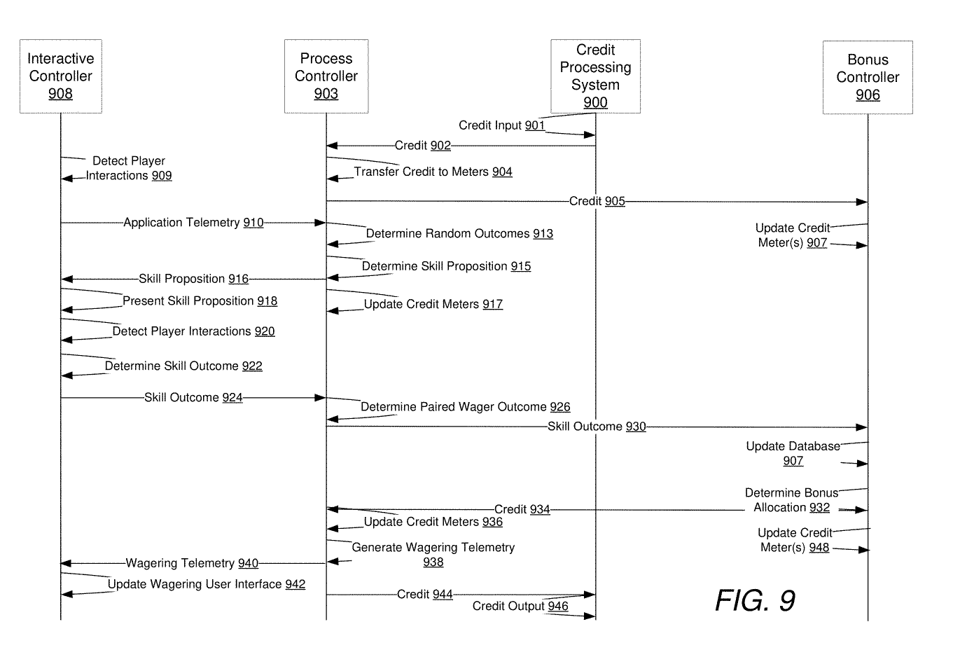

FIG. 9 is a sequence diagram of interactions between components of an adaptive wagering system during a wagering session in accordance with various embodiments of the invention. The components of the adaptive wagering system include a process controller 903, an interactive controller 908, a credit processing system 900, and a skill bonus controller 906.

In some embodiments, at a beginning of the wagering session, the process includes a credit input 901 to the adaptive wagering system with process controller 903 communicating with the credit processing system 900 to receive incoming credit data 902. The process controller 903 uses the incoming credit data to transfer 904 credits onto one or more credit meters associated with one or more players of the adaptive wagering system, thus transferring credits into the adaptive wagering system and on to the one or more credit meters.

In many embodiments, the interactive controller 908 detects 909 one or more players performing a player interaction in an application interface of an interactive application provided by the interactive controller 908. The interactive controller 908 communicates application telemetry data 908 to the process controller 903. The application telemetry data 908 includes, but is not limited to, the player interaction detected by the interactive controller 908.

The process controller 903 receives the application telemetry data 910. Upon determination by the process controller 903 that the player interaction indicates a wagering event in accordance with a paired wagering proposition, the process controller 903 determines 913 one or more random outcomes of the paired wagering proposition and associates the one or more random outcomes to a 915 skill proposition of the paired wagering proposition. The process controller 903 communicates data of the skill proposition 916 to the interactive controller 908. The process controller 903 updates 917 one or more credit meters associated with the one or more players based on amounts of credits committed to the paired wager. The process controller communicates data of an amount of credits 905 to the skill bonus controller 906. The skill bonus controller receives the data of the amount of credits and updates 907 one or more bonus pool credit meters using data of the amount of credits 905.

The interactive controller 908 receives the skill proposition data 916 from the process controller 903 and uses the skill proposition data 916 to generate and present 918 to the one or more players a skill proposition. The presentation of the skill proposition is presented to the one or more players in the user interface of the interactive application of the interactive controller 908. The interactive controller 908 detects 920 player interactions of the one or more players with the presentation of the skill proposition and determines 922 a skill outcome based on the detected player interactions and the skill proposition data 916. The interactive controller 908 communicates data of the skill outcome 924 to the process controller 903.

The process controller 903 receives the skill outcome data 924 and determines 926 a paired wager outcome using the skill outcome and the one or more random outcomes as described herein. The process controller communicates data of the skill outcome 930 to the skill bonus controller 906.

The skill bonus controller receives the skill outcome data 930 and updates a bonus database using the skill outcome data. The skill bonus controller 906 uses the skill outcome data 930 and bonus allocation rules to determine 932 a skill bonus of an amount of credits to be provided to the player as described herein. The skill bonus controller 906 communicates data of the amount of bonus credits 934 to the process controller 903. The skill bonus controller updates 948 one or more skill bonus controller credit meters using the skill bonus of an amount of credits.

The process controller 903 receives the data of the amount of credits to be used as a skill bonus and updates 936 the one or more credit meters associated with the one or more players using the paired wager outcome and the skill bonus. The process controller 903 generates 938 wagering telemetry data 940 using data of the paired wager outcome, data of the skill bonus and the updated one or more credit meters. The process controller 903 communicates the wagering telemetry data 940 to the interactive controller 908.

The interactive controller 908 receives the wagering telemetry data 940. The interactive controller 908 updates 942 a wagering user interface on a partial basis of the wagering telemetry data 940.

In many embodiments, upon determining that the wagering session is completed, such as by receiving a cashout communication from one or more players of the adaptive wagering system, the process controller 903 transfers credits off of the one or more credit meters, generates outgoing credit data 940 on the basis of the credits transferred off of the one or more credit meters, and communicates the outgoing credit data 940 to the credit processing system 900. The credit processing system receives the outgoing credit data 940 and generates 942 a credit output as described herein, thus transferring credits off of the one or more credit meters and out of the adaptive wagering system.

In some embodiments, at a beginning of the wagering session, the process includes an application credit input to the adaptive wagering system with the process controller 903 communicating with the credit processing system 900 to receive incoming application credit data. The process controller 902 uses the incoming application credit data to transfer application credits onto one or more application credit meters associated with one or more players of the adaptive wagering system, thus transferring application credits into the adaptive wagering system and on to the one or more application credit meters. The process controller 903 uses the skill outcome data 924 to determine an amount of application credit to award to a player based on the player's skillful interactions with an interactive application executed by the interactive controller 905. Upon determining that the wagering session is completed, such as by receiving a cashout communication from one or more players of the adaptive wagering system, the process controller 903 transfers application credits off of the one or more application credit meters, generates outgoing application credit data on the basis of the application credits transferred off of the one or more application credit meters, and communicates the outgoing application credit data to the credit processing system 900. The credit processing system receives the outgoing application credit data and generates an application credit output as described herein, thus transferring application credits off of the one or more application credit meters and out of the adaptive wagering system.

In some embodiments, an adaptive wagering system has a skill bonus pool. In many such embodiments, the wager subcontroller allocates a portion of a wager or a random outcome to a skill bonus pool credit meter. The wager subcontroller may take credits from the skill bonus pool as an outcome of a paired wagering proposition.

In some embodiments, the process controller determines what resources and commands to provide to the interactive controller for use by the interactive application provided by the interactive controller partially on the basis of the random outcome. In some such embodiments, resources are provided in a case that the wager was a winning wager for the player. In other such embodiments, fewer or no resources are provided in a case of a losing wager.

In some embodiments, the process controller determines what resources to provide based on internal logic of the process controller. In some such embodiments, the process controller employs a random outcome generator, such as a random number generator, to generate a random outcome and the random outcome is used to determine what resources are provided to the interactive controller.

In several embodiments, the process controller determines an increment or a decrement of an amount of AC using the interactions received from the interactive controller. The increment or decremented amount is communicated to the interactive controller for display to the player.

In some embodiments, the process controller executes a wager of Cr as a virtual currency, AC, interactive elements or objects. In some such embodiments, the process controller employs a random outcome generator, such as a random number generator, to generate a random outcome and the random outcome is used to determine a random outcome in Cr as a virtual currency, AC, interactive elements or objects.

In many embodiments, a session/management controller of an adaptive wagering system is used to store AC for use of the player. In such an embodiment, AC is generated by the process controller based on the player's use of the adaptive wagering system and an amount of the AC is communicated to the session/management controller. The session/management controller stores the amount of AC between sessions. In some embodiments, the session/management controller communicates an amount of AC to the process controller at the start of a session for use by the player during a session.

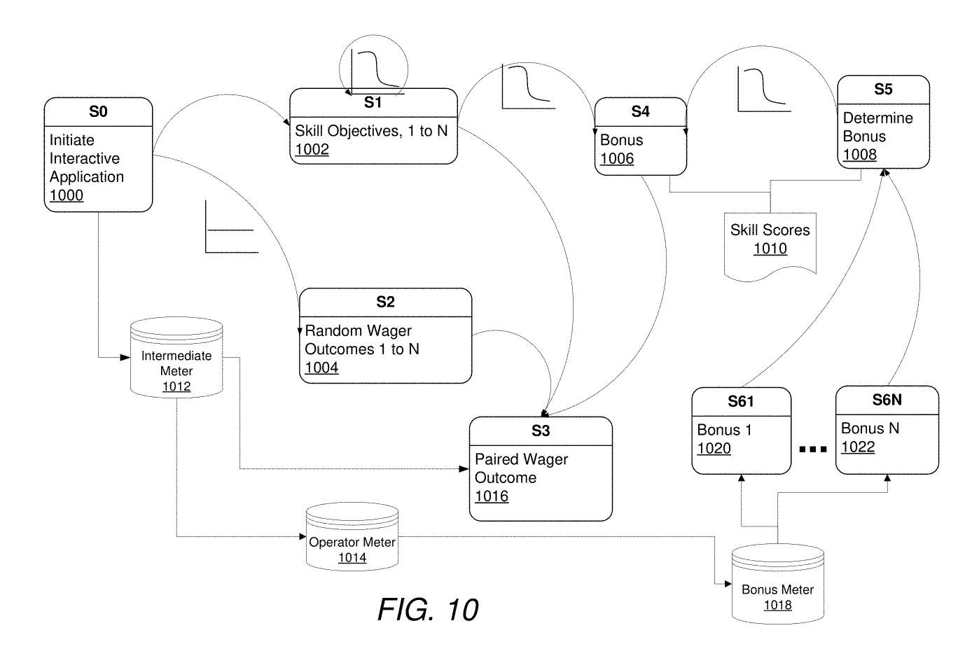

FIG. 10 is a state diagram of a wagering process of an adaptive wagering process in accordance with an embodiment of the present invention. In a state zero 1000, an interactive application is initiated. The interactive application provides a skill-based game to a player. As the player skillfully plays the skill-based game, a skill score is determined for the player. In a state two 1004, one or more random outcomes are generated for a paired wagering proposition using a random number generator having a uniform distribution, and a paytable. Each of the one or more random outcomes includes an associated amount of credits and each of the one or more random outcomes is associated with one or more skill objectives of the skill-based game. The credits associated with the one or more random outcomes are transferred into an intermediate credit meter 1012 pending determination of a paired wager outcome in the skill-based game.

In a state one 1002, the player skillfully plays the skill-based game attempting to achieve one or more skill objectives of the skill-based game. As the player skillfully plays the skill-based game, an individual skill score is determined for the player indicating the player's skill at the skill-based game. A probability that the player can achieve a specific skill score value can be described as a cumulative probability determined from skill score data collected from other players as the other players play the skill-based game.

In a state three 1016, the random outcomes are allocated to the player in a paired wager outcome based on a number of skill objectives achieved by the player.

Credits for the amounts of credits associated with the random outcomes are provided from the intermediate credit meter. Any credit amounts associated with unachieved skill objectives are transferred to an operator credit meter 1014 as part of the operators gross gaming revenue. A portion of the credits in the operator credit meter are provided to a bonus pool credit meter 1018 for use in providing a skill bonus as described herein.

In a state four 1006, a determination is made of whether or not the player's skillful play of the skill-based game, as measured by the player's individual skill metric, indicates that the player should be awarded a skill bonus. A probability that the player's skillful play as measured by the individual skill score will result in a skill bonus being awarded the player can be determined from a cumulative probability distribution determined from data 1010 of historical player skill scores collected as other players skillfully play the skill-based game.

In a state five 1008, a specific one of one or more skill bonuses, represented by states six one 1020 to six N 1022, is determined for a player based on the player's individual skill score and a comparison to the historical skill scores 1010 of the other players. Credits awarded to the player in the skill bonuses are provided from the skill bonus pool credit meter 1018. The skill bonus determined in state four 1006 is added to the paired wager outcome determined in state three 1016

In an embodiment, if an amount of credits awarded to a player as the paired wager outcome is less than an amount of credits wagered by the player then a skill bonus greater than the amount of credits is awarded to the player.

In an embodiment, the skill-based game generates a skill score for a player that can be described by a monotonically increasing function. As the player's individual skill score increases in value, the player is deemed to have achieved a skill objective when the player's individual skill score reaches a specified threshold associated with the skill objective. Whether or not the player is awarded a skill bonus is determined if the player's individual skill score has achieved a specified threshold percentile ranking as compared to the historical skill score data. A specific skill bonus awarded to the player is determined on the basis of the player's individual skill score falling within a specified range of percentile rankings.

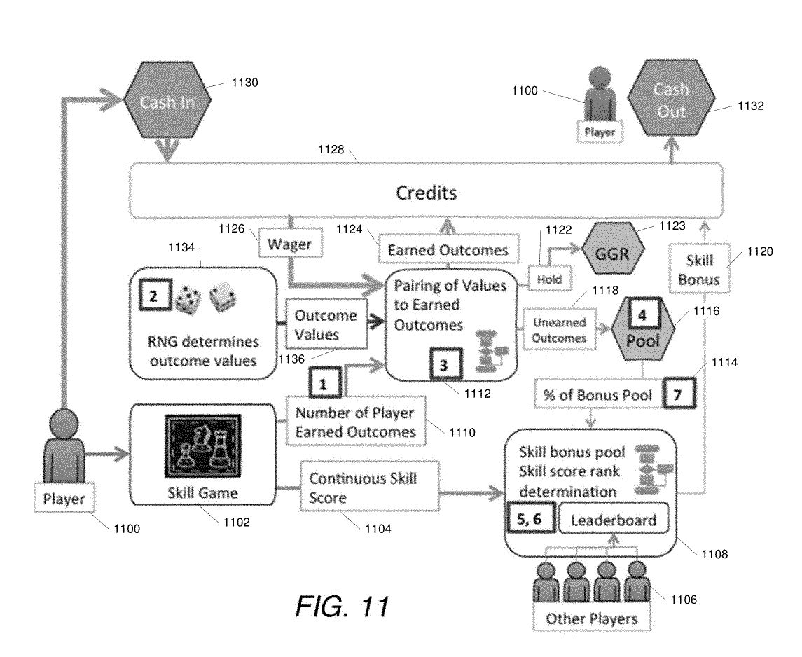

FIG. 11 is a process flow diagram of a wagering process of an adaptive wagering system in accordance with an embodiment of the present invention. In the process, a player 1100 cashes in 1130 using an amount of credits 1128 and plays a skill game 1102 that determines a discrete number of earned outcomes 1110 in the game and also creates a player skill score 1104 for that game session.

One or more random outcome values 1136 are determined 1134 by a random number generator (RNG) and an outcome table similar to multiline slot math to produce potential wins.

The earned outcomes are paired 1112 to the random outcome values up to the amount of earned outcomes 1110 to determine one portion of the pays for the game as paired wager outcome. The credits for the pays is are taken from a wager 1126 of an amount of credits 1128. This results in a more skillful player earning most or all of the random outcome values as earned outcomes 1124 that are credited back to the player's credit meter 1128 while a less skillful play earns less than the total number of random outcomes.

A portion of the committed wager credits are held 1122 as gross gaming revenue (GGR) 1123.

The pays associated with the unearned outcomes 1118 are aggregated into a skill bonus pool 1116 on a skill bonus pool credit meter from multiple plays of the same game of that type (theme).

For a supplemental benefit of pays (a skill bonus of an amount of credits 1120), the player's skill score 1104 is ranked against the skill score of other previous players 1106 of the games by comparing 1108 the player's skill score to a leaderboard of the skill scores of the other previous players. This is a continuum and the leaderboard evolves over time with the total population of players playing the game.

If the skill score of player falls within a fixed specified band of skill scores of the other previous players, a skill bonus 1120 of an amount of credits of a portion of the skill bonus pool 1114 is awarded from the skill bonus pool to the individual player. In an example embodiment, if the individual player's skill score places the individual player in the top 10% of all players who've played the game, the player receives a skill bonus.

The value of the amounts of credits of the skill bonus 1114 is determined as a percentage of the currently available skill bonus pool 1116. In an example embodiment, the percentage of the bonus pool credits allocated to the skill bonus pool 1114 is a function determined by the amount of money in the pool and the pools rate of change of its size (growing or shrinking).

At an end of the wagering process, the player 1100 cashes out 132 the player's credits are transferred off of the wagering system as described herein.

In another example embodiment, players average 85% return to player (RTP) on the skill game 1102, but the effect of the skill bonus drawn from the skill bonus pool appending to the wins of the better players (as cited above) raises the average RTP of the game up to 92%.

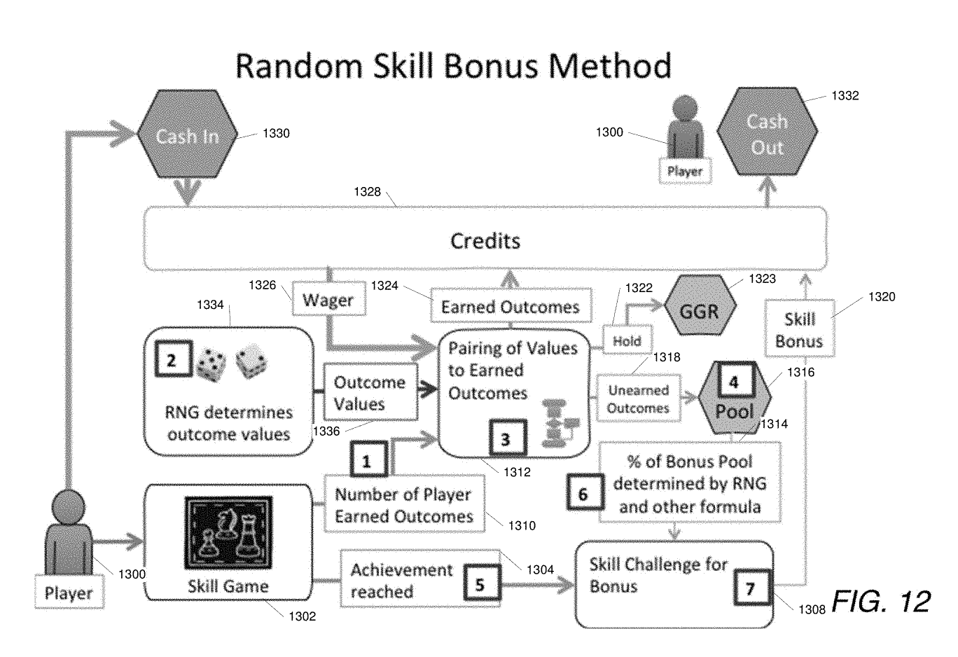

FIG. 12 is a process flow diagram of another wagering process of an adaptive wagering system in accordance with an embodiment of the present invention.

In the process, a player 1300 cashes in 1330 an amount of credits transferring credits into the wagering system. The player plays a skill game 1302 that determines a discrete number of earned outcomes 1310 in the game and also creates a player skill score 1304 for that game session.

Multiple random outcome values 1334 are determined by a random number generator (RNG) and an outcome table similar to multiline slot math to produce outcome values 1336 that are potential wins.

The earned outcomes are paired 1312 to the random outcome values 1336 up to the amount of earned outcomes to determine one portion of the pays for the game as earned outcomes 1324 of a paired wager outcome. This results in a more skillful player earning most or all of the random outcome values 1336 while a less skillful play earns less than the total number of outcomes

The pays associated with the unearned outcomes 1318 are aggregated into a skill bonus pool of credits 1316 from multiple plays of the same game of that type (theme).

For a supplemental benefit of pays of amounts of credits (a bonus), upon a pre-determined and declared achievement 1304 in the skill game 1302, the player enters a skill challenge bonus round 1308.

In the bonus round, the size of the prize is determined 1314 by a random number generator, equalized around the wager commitment size/denom of the game, as well as a factor to adjust the size of the prize where the factor is determined by the amount of credits in the pool 1316 and the pools rate of change of its size (growing or shrinking).

If the player is successful on the skill objective(s) in the bonus round, then they win an amount of credits as a skill bonus 1320.

A portion of the amount of credits committed as a wager 1326 are added as a hold 1322 amount of credits to the amount of credits of a gross gaming revenue meter 1323.

At an end of the wagering process, the player 1300 cashes out 1332, thus transferring credits 1328 off of the wagering system.

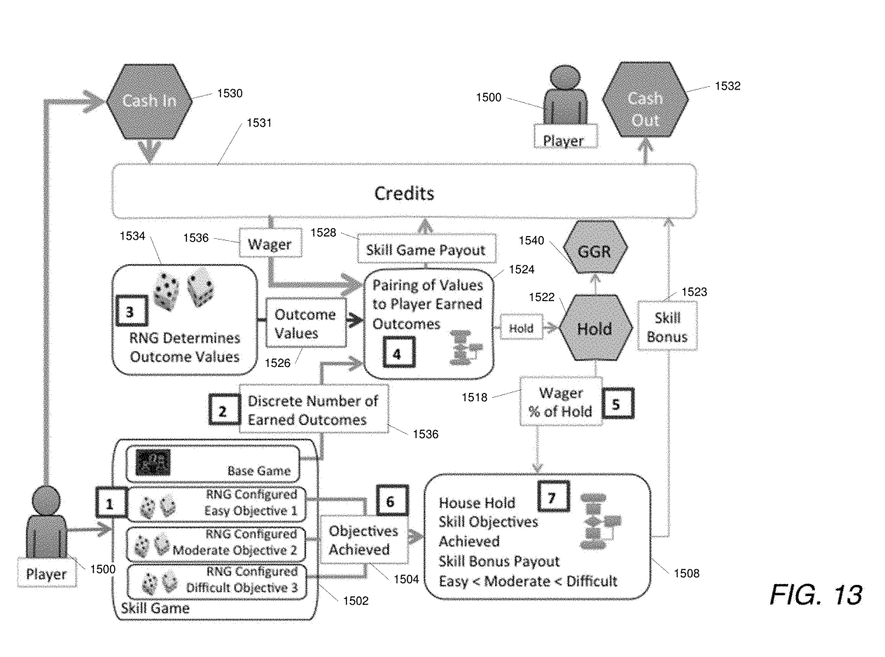

FIG. 13 is a process flow diagram of another wagering process of an adaptive wagering system in accordance with an embodiment of the present invention.

In the process, a player 1500 cashes in 1530 and an amount of credits 1531 are transferred into the wagering system. The player 1500 plays a skill game 1502 wherein a quantity of a key resource(s) (in example embodiments, resources include bullets, health, and or fuel) needed to achieve one or more skill objectives of the game is determined by a random number generator (RNG).

The player plays the skill game that determines a discrete number of earned outcomes 1536 in the skill game.

At the same time, multiple random outcome values 1526 are determined 1534 by an RNG and an outcome table similar to multiline slot math to produce potential wins.

The earned outcomes 2536 are paired 1524 to the random outcome values up to the amount of earned outcomes to determine one portion of the pays for skill game payout 1528 of the game as a paired wager outcome. In this case of this portion, a more skillful player earns most or all of the random outcome values while a less skillful play earns the player less than the total number of random outcomes, thereby generating greater hold 1522 of an amount of credits of an amount of credits committed as a wager 1536. A portion of the amount of credits of the hold 1522 is accreted to an amount of credits of gross gaming revenue 1540.

For a second portion of pays of amounts of credits, each skill objective of the skill game 1502 is part of a side bet that is made on the player's behalf, but an amount of credits for a commitment of credits for the wager 1518 for each side bet is taken from the amount of credits of the hold 1522 of the game and not from the player's original amount of credits committed as an amount of credits for the wager 1536.

The skill game also determines the player's achievement 1504 of complex skill objectives of the skill game 1502. The complex skill objectives are independent and the player may achieve none to all of the skill objectives while playing the skill game and earn 1508 payouts of an amount of credits as an amount of credits of a skill bonus 1523 for the skill objectives independently of each of the other skill objectives

In various embodiments, easier skill objectives pay less than the more difficult skill objectives. The amount of these pays would adjust over time based on how well player's accomplish them.

At the end of the wagering process, the player 1500 cashes out 1532 thus transferring an amount of credits 1531 off of the wagering system.

While the above description may include many specific embodiments of the invention, these should not be construed as limitations on the scope of the invention, but rather as examples of embodiments thereof. It is therefore to be understood that the invention can be practiced otherwise than specifically described, without departing from the scope and spirit of the invention. Thus, embodiments of the invention described herein should be considered in all respects as illustrative and not restrictive.

What is claimed:

1. An adaptive wagering system, comprising:
an interactive controller;
a skill bonus controller; and
a process controller constructed to communicate with the interactive controller and the skill bonus controller.

2. The adaptive wagering system of claim 1, wherein the interactive controller and the process controller are constructed from the same device.

3. The adaptive wagering system of claim 1, wherein the process controller is operatively connected to the interactive controller using a communication link.

4. The adaptive wagering system of claim 1, further comprising:
an enclosure constructed to mount:
a user input device operatively connected to the interactive controller;
a user output device operatively connected to the interactive controller;
a credit input device operatively connected to the process controller; and
a credit output device operatively connected to the process controller

5. The adaptive wagering system of claim 4, further comprising a random number generator, wherein the process controller is further constructed to:
communicate with the credit input device to receive a credit input;
credit a credit meter with credits based on the incoming credit data;
generate a random outcome based on a random outcome generated by the random number generator;
determine a skill proposition based on the random outcome;
communicate the skill proposition to the interactive controller;
receive a skill outcome from the interactive controller;
update the credit meter based on a chance outcome of the wager; and
communicate with the credit output device to generate a credit output based on credits transferred off of the credit meter, and
wherein the interactive controller is further constructed to:
receive the skill proposition from the process controller;
generate a player presentation based on the skill proposition;
detect player interactions with the player presentation;
determine a skill outcome based on the player interactions and the skill proposition; and
communicate the skill outcome to the process controller.
